(19) United States
(12) Patent Application Publication
(10) Pub. No.: US 2011/0181521 A1
(43) Pub. Date: Jul. 28, 2011

(54) TECHNIQUES FOR CONTROLLING Z-ORDERING IN A USER INTERFACE

(75) Inventors: Elizabeth Gloria Guarino Reid, San Francisco, CA (US); Kurt Allen Revis, Portland, OR (US)

(73) Assignee: APPLE INC., Cupertino, CA (US)

(21) Appl. No.: 12/694,214

(22) Filed: Jan. 26, 2010

(51) Int. Cl. G06F 3/041; G06F 3/048

(52) U.S. Cl. 345/173; 715/766

(57) ABSTRACT

Systems and methods are disclosed for a z-order editing process that adjusts the z-ordering of selected objects displayed on a user interface. The z-ordering editing process may include identifying one or more selected objects and providing a z-ordering editing mode having an interactive graphical adjustment tool. The interactive graphical adjustment tool may receive user inputs indicating a desired direction for z-ordering adjustment. Changes in the z-ordering of the selected objects may be applied and dynamically previewed before ultimately being accepted by a user.

### BACKGROUND

The present disclosure relates generally to electronic devices having a display, and, more particularly to techniques for controlling the z-ordering of user interface objects displayed on such an electronic device.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

One use which has been found for computers has been to facilitate the communication of information to an audience. For example, it is not uncommon for various types of public speaking, (such as lectures, seminars, classroom discussions, keynote addresses, and so forth), to be accompanied by computer generated presentations that emphasize or illustrate points being made by the speaker. For example, such presentations may include music, sound effects, images, videos, text passages, numeric examples or spreadsheets, or audiovisual content that emphasizes points being made by the speaker.

Typically, these presentations are composed of “slides” that are sequentially presented in a specified order. These slides may contain audiovisual content in the form of objects placed on the slides. One challenge that may face those who create such presentations are the complexities involved in create and modifying the slides and objects used in a presentation and the association of effects with such slides and objects. For instance, when presented on a display, the objects may each have an associated horizontal and vertical position in an x-y plane.

In some applications, the objects may also have an associated position in the z-direction (often referred to as a z-order), which may convey depth to a user. For instance, each object may be ordered as being above or beneath the other objects as they appear on the slide, such that higher z-ordered objects may be depicted as overlying or obscuring lower z-ordered objects. One challenge that may face those who create such presentations are the complexities involved in create and modifying the slides and objects used in a presentation and the association of effects with such slides and objects. However, existing presentation applications may not provide an intuitive and interactive interface for adjusting the z-ordering of such objects displayed on such slides.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure generally relates to a z-order editing process for adjusting the z-ordering of objects displayed on a user interface of an application. By way of example, in the context of a presentation application, the z-ordering adjustment process may include identifying one or more selected objects within a slide and then providing a z-ordering editing mode that provides an interactive graphical adjustment tool. Using the interactive graphical adjustment tool, a user may provide inputs indicating a desired direction for z-ordering adjustment. Changes in the z-ordering of the selected objects may be applied, displayed, and previewed dynamically or interactively on the slide.

The z-order editing process may include the ability to adjust multiple concurrently selected objects, such that the selected objects retain their relative z-ordering positions with respect to one another after the adjustment. The z-order editing process may also provide the ability to move multiple concurrently selected objects as a group, such that the selected objects become contiguous after the adjustment, even if the z-ordering of the selected objects was not contiguous prior to the adjustment.

### BRIEF DESCRIPTION OF THE DRAWINGS

Various aspects of this disclosure may be better understood upon reading the following detailed description and upon reference to the drawings in which:

FIG. 1 is a block diagram of exemplary components of an electronic device that may be used in conjunction with aspects of the present disclosure;

FIG. 2 is a perspective view of an electronic device in the form of a computer that may be used in conjunction with aspects of the present disclosure;

FIG. 3 is a perspective view of a tablet-style electronic device that may be used in conjunction with aspects of the present disclosure;

FIG. 4 depicts a screen of a presentation application used for generating slides in accordance with aspects of the present disclosure;

FIGS. 5 to 12 depict screens illustrating a technique for adjusting the z-ordering of a single selected object from a group of objects displayed in a slide of a presentation application in accordance with aspects of the present disclosure;

FIG. 13 is a flow chart depicting a method for adjusting the z-ordering of a single selected object from a group of objects, as shown in FIGS. 5-12, in accordance with aspects of the present disclosure;

FIGS. 14 and 15 depict screens illustrating a technique for adjusting the z-ordering of multiple contiguous objects selected from a group of objects displayed in a slide of a presentation application in accordance with aspects of the present disclosure;

FIGS. 16 to 20 depict screens that illustrating a technique for adjusting the z-ordering of multiple non-contiguous objects selected from a group of objects displayed in a slide of a presentation application in accordance with aspects of the present disclosure;

FIG. 21 is a flow chart depicting a method for adjusting the z-ordering of multiple contiguous objects, as shown in FIGS. 14 and 15, and adjusting the z-ordering of multiple non-contiguous objects, as shown in FIGS. 16 to 20, in accordance with aspects of the present disclosure;

FIGS. 22 to 24 depict screens illustrating another technique for adjusting the z-ordering of multiple non-contiguous objects selected from a group of objects displayed in a slide of a presentation application in accordance with aspects of the present disclosure; and

FIG. 25 is a flow chart depicting a method for adjusting the z-ordering of multiple non-contiguous objects, as shown in FIGS. 22 to 24, in accordance with aspects of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure is directed to a technique for adjusting or manipulating the z-ordering of objects displayed on a user interface of an application. As used herein, the term “object” may refer to any individually editable component that may be displayed within a particular application, such as on a slide of a presentation application, within a document of a word processing application, within a spreadsheet in a spreadsheet application, or within an editing workspace of an image editing application. For instance, objects may include images, photo, text characters, line drawings, clip-art, charts, tables, embedded video and audio, and so forth. By way of example, in the context of a presentation application, the z-ordering adjustment process may include identifying one or more selected objects within a slide and then entering a z-ordering editing mode that provides an interactive graphical adjustment tool. Using the interactive graphical adjustment tool, a user may provide inputs indicating a desired direction for z-ordering adjustment. As the user interacts with the interactive graphical adjustment tool, changes based on the user inputs may be applied and displayed and previewed dynamically on the slide, although such changes are not fixed until the user exits the z-ordering editing mode. It should be understood that “interactively,” “dynamically,” “dynamic preview” or the like, as used herein, means the slide is continuously updated based upon the adjustments invoked by the user, such that the user does not perceive a noticeable delay or lag between the time in which the adjustment is made (e.g., via the interactive graphical tool) and the time at which the slide is updated to reflect the adjustment (e.g., substantially real-time).

In accordance with certain embodiments, the z-order editing process includes the ability to adjust multiple concurrently selected objects, such that the selected objects retain their relative z-ordering positions with respect to one another after the adjustment. In one embodiment, the z-order editing process includes the ability to move multiple concurrently selected objects as a group, such that the adjusted z-order positions results in the selected objects being contiguous, even if the z-ordering of the selected objects was not contiguous prior to the adjustment. In a further embodiment, the z-order editing process includes the ability to move multiple concurrently selected objects, such that the z-order spacing between the selected objects is retained following the adjustment.

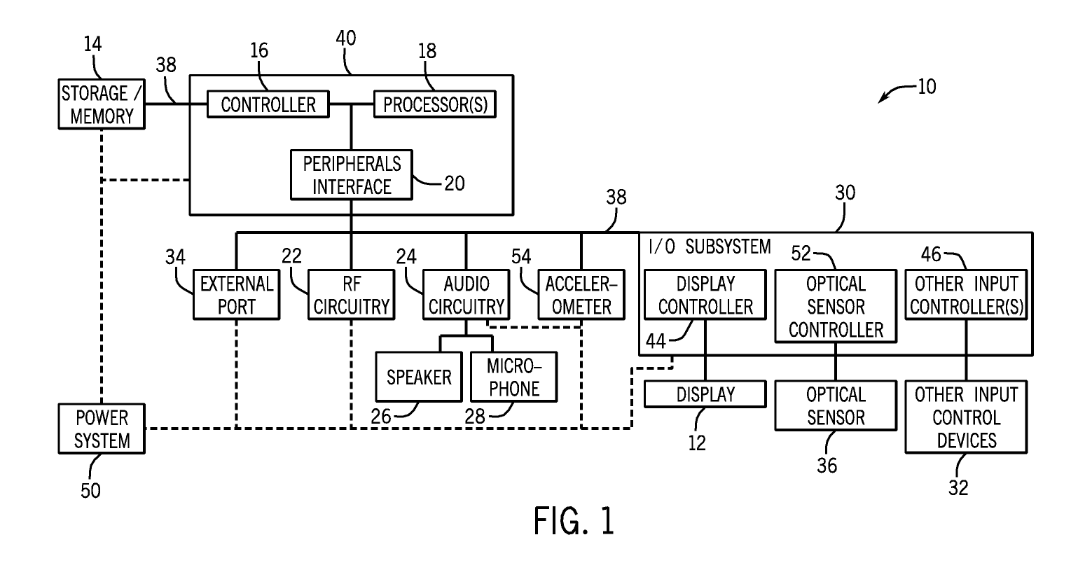

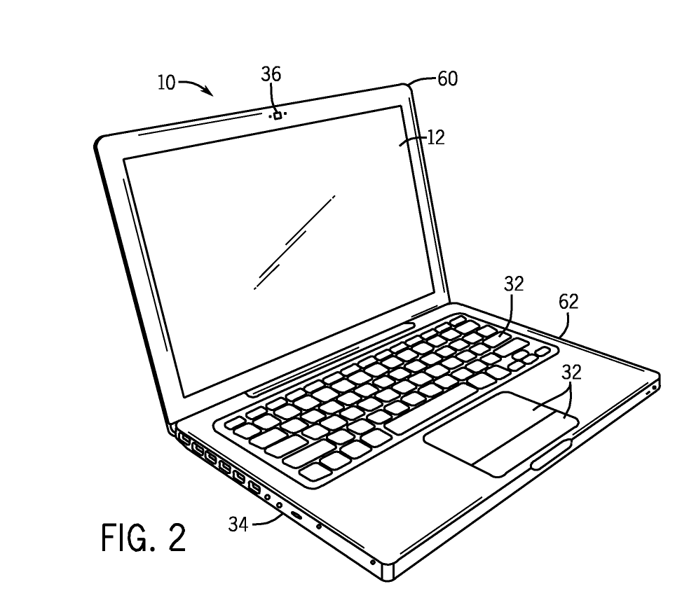

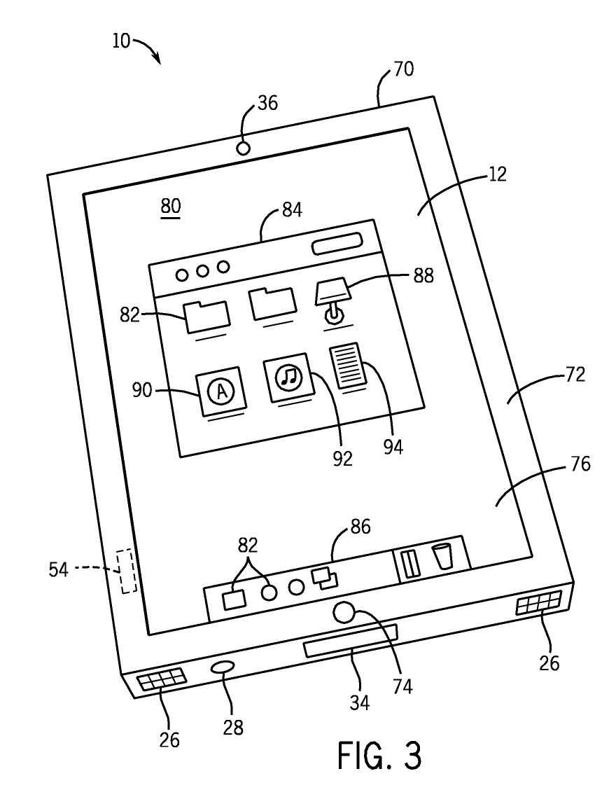

With these foregoing features in mind, a general description of suitable electronic devices for performing these functions is provided below. In FIG. 1, a block diagram depicting various components that may be present in electronic devices suitable for use with the present techniques is provided. In FIG. 2, one example of a suitable electronic device, here provided as a computer system, is depicted. In FIG. 3, another example of a suitable electronic device, here provided as a tablet-style device, is depicted. These types of electronic devices, and other electronic devices providing comparable display capabilities, may be used in conjunction with the present techniques.

An example of a suitable electronic device may include various internal and/or external components that contribute to the function of the device. FIG. 1 is a block diagram illustrating the components that may be present in such an electronic device 10 and which may allow the device 10 to function in accordance with the techniques discussed herein. As will be appreciated, various components of electronic device 10 may be provided as internal or integral components of the electronic device 10 or may be provided as external or connectable components. It should further be noted that FIG. 1 is merely one example of a particular implementation and is intended to illustrate the types of components and/or functionalities that may be present in electronic device 10.

In various embodiments, the electronic device 10 may be a media player, a cellular telephone, a laptop computer, a desktop computer, a tablet computer, a personal data organizer, an e-book reader (e-reader), a workstation, or the like. For example, in certain embodiments, the electronic device 10 may be a portable electronic device, such as a tablet device or a model of an iPod® or iPhone® available from Apple Inc. of Cupertino, Calif. In other embodiments, electronic device 10 may be a desktop, tablet, or laptop computer, including a MacBook®, MacBook® Pro, MacBook Air®, iMac®, Mac® Mini, or Mac Pro®, also available from Apple Inc. In further embodiments, electronic device 10 may include other models and/or types of electronic devices suitable for implementing the features disclosed herein.

As discussed herein, the electronic device 10 may be used to store and/or execute a variety of applications. Such applications may include, but are not limited to: drawing applications, presentation applications, a word processing applications, website creation applications, disk authoring applications, spreadsheet applications, gaming applications, telephone applications, video conferencing applications, e-mail applications, instant messaging applications workout support applications, photo management applications, digital camera applications digital video camera applications, web browsing applications, e-book reader applications, digital music player applications, and/or digital video player applications. Further, the electronic device 10 may be used to store, access, and/or modify data, routines, and/or drivers used in conjunction with such applications.

Various applications that may be executed on the electronic device 10 may utilize or share the same user interface devices, such as a touch-sensitive surface (e.g., a touch screen or touch pad), a mouse, a keyboard, and so forth. One or more functions of such interface devices, as well as corresponding information displayed on the electronic device 10, may be adjusted and/or varied from one application to the next and/or within a respective application. In this way, a common physical architecture (such as the interface devices provided by the electronic device 10) may support a variety of applications with user interfaces that are intuitive and transparent.

The depicted electronic device includes a display 12. In one embodiment, the display 12 may be based on liquid crystal display (LCD) technology, organic light emitting diode (OLED) technology, or light emitting polymer display (LPD) technology, although other display technologies may be used in other embodiments. In accordance with certain embodiments, the display 12 may include or be provided in conjunction with touch sensitive elements. Such a touch-sensitive display may be referred to as a “touch screen” and may also be known as or called a touch-sensitive display system.

In addition, the electronic device 10 may include one or more storage/memory components 14 (which may include one or more computer readable storage mediums), a memory controller 16, one or more processing units (CPUs, GPUs, and so forth) 18, a peripherals interface 20, RF circuitry 22, audio circuitry 24, a speaker 26, a microphone 28, an input/output (I/O) subsystem 30, input and/or control devices 32, and an external port 34. Further, in certain embodiments, the electronic device 10 may include one or more optical sensors 36. These components may communicate over one or more communication buses or signal lines 38.

It should be appreciated that the depicted electronic device 10 is only one example of a suitable device, and that the electronic device 10 may have more or fewer components than shown, may combine the functionality of two or more of the depicted components into a single component, or a may have a different configuration or arrangement of the components. Further, the various components shown in FIG. 1 may be implemented in hardware (including circuitry), software (including computer code stored on a computer-readable medium), or a combination of both hardware and software, including one or more signal processing and/or application specific integrated circuits.

With respect to the specific depicted components, the storage/memory component(s) 14 may include high-speed random access memory and/or may also include non-volatile memory, such as one or more magnetic disk storage devices, flash memory devices, or other non-volatile solid-state memory devices. Access to storage/memory components 14 by other components of the device 10, such as the processor 18 and the peripherals interface 20, may be controlled by one or more respective controllers 16, such as a memory controller, disk controller, and so forth.

The peripherals interface 20 couples various input and output peripherals of the electronic device 10 to the processor 18 and storage/memory components 14. The one or more processors 18 run or execute various software programs and/or sets of instructions stored in storage/memory components 14 (such as routines or instructions to implement the features discussed herein) to perform various functions on the electronic device 10 and/or to process data. In some embodiments, the peripherals interface 20, the processor 18, and the memory controller 16 may be implemented on a single chip, such as a chip 40. In other embodiments, these components and/or their functionalities may be implemented on separate chips.

The RF (radio frequency) circuitry 22 receives and sends RF signals, also called electromagnetic signals. The RF circuitry 22 converts electrical signals to/from electromagnetic signals and communicates with communications networks and other communications devices via the electromagnetic signals. The RF circuitry 22 may include known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 22 may communicate with networks, such as the Internet, also referred to as the World Wide Web (WWW), an intranet and/or a wireless network, such as a cellular telephone network, a wireless local area network (LAN) and/or a metropolitan area network (MAN), and/or other devices by wireless communication. The wireless communication may use any suitable communications standard, protocol and/or technology, including but not limited to Global System for Mobile Communications (GSM), Enhanced Data GSM Environment (EDGE), a 3G network (e.g., based upon the IMT-2000 standard), high-speed downlink packet access (HSDPA), wideband code division multiple access (W-CDMA), code division multiple access (CDMA), time division multiple access (TDMA), a 4G network (e.g., based upon the IMT Advanced standard), Long-Term Evolution Advanced (LTE Advanced), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), Multimedia Messaging Service (MMS), and/or Short Message Service (SMS), or any other suitable existing or later developed communication protocol.

The audio circuitry 24, the speaker 26, and the microphone 28 provide an audio interface between a user and the electronic device 10. In one embodiment, the audio circuitry 24 receives audio data from the peripherals interface 20, converts the audio data to an electrical signal, and transmits the electrical signal to the speaker 26. The speaker 26 converts the electrical signal to audible sound waves. The audio circuitry 24 also receives electrical signals converted by the microphone 28 from sound waves. The audio circuitry 24 converts the electrical signal to audio data and transmits the audio data to the peripherals interface 20 for processing. Audio data may be retrieved from and/or transmitted to the storage/memory components 14 and/or the RF circuitry 22 by the peripherals interface 20. In some embodiments, the audio circuitry 24 may include an output jack (e.g., an audio out jack or a headset jack). The output jack provides an interface between the audio circuitry 24 and removable audio input/output peripherals, such as output-only speakers, headphones or a headset with both output (e.g., a headphone for one or both ears) and input (e.g., a microphone).

The I/O subsystem 30 couples input/output peripherals on the electronic device 10, such as a display 12, and other input/control devices 32, to the peripherals interface 20. The I/O subsystem 30 may include a display controller 44 and one or more input controllers 46 for other input or control devices. The one or more input controllers 46 receive/send electrical signals from/to other input or control devices 32. The other input/control devices 32 may include physical buttons (e.g., push buttons, rocker buttons, etc.), dials, slider switches, joysticks, click wheels, a touch pad, and so forth. In some alternate embodiments, the input controller(s) 46 may be coupled to any (or none) of the following: a keyboard, infrared port, USB port, and/or a pointer device such as a mouse. Examples of input/control devices 32 in the form of buttons may include an up/down button for volume control of the speaker 26 and/or the microphone 28, on/off buttons, and/or buttons used to invoke a home screen on the display 12 of the electronic device 10.

When present, a display 12 implemented as a touch screen provides an input interface and an output interface between the electronic device 10 and a user. In one such embodiment, the display controller 44 receives and/or sends electrical signals from/to the display 12 and the corresponding touch sensitive elements. The display 12 displays visual output to the user. The visual output may include graphics, alphanumeric characters, icons, video, and so forth (collectively termed “graphics”). In some embodiments, some or all of the visual output may correspond to user-interface objects.

In embodiments employing a touch screen, the display 12 has a touch-sensitive surface, sensor or set of sensors that accepts input from the user based on haptic and/or tactile contact. The touch screen and the display controller 44 generate signals in response to contact (and any movement or breaking of the contact) on the display 12, and the signals may be received and processed in accordance with routines executing on the processor 18 such that the signals (and the contact they represent) are recognized as interactions with user-interface objects that are displayed on the display 12. In an exemplary embodiment, a point of contact between a touch screen 12 and the user corresponds to an appendage, e.g., a finger, of the user, and/or a stylus wielded by the user.

In embodiments where a touch screen is employed, the display 12 and the display controller 44 may detect contact and/or movement (or breaks in such movement) using a suitable touch sensing technologies, including but not limited to capacitive, resistive, infrared, and surface acoustic wave technologies, as well as other proximity sensor arrays or other elements for determining one or more points of contact with the display 12. The user may make contact with such a touch sensitive display 12 using any suitable object or appendage, such as a stylus, a finger, and so forth. In some embodiments, a touch-sensitive display may be multi-touch sensitive, i.e., sensitive to multiple concurrent contacts. In an exemplary embodiment, projected mutual capacitance sensing technology is used, such as that found in the iPhone® and iPod Touch® from Apple, Inc. of Cupertino, Calif.

The electronic device 10 also includes a power system 50 for powering the various components. The power system 50 may include a power management system, one or more power sources (e.g., battery, alternating current (AC)), a recharging system, a power failure detection circuit, a power converter or inverter, a power status indicator (e.g., a light emitting diode (LED)) and any other components associated with the generation, management and distribution of power in electronic devices.

The electronic device 10 may also include one or more optical sensors 36. FIG. 1 shows an optical sensor 36 coupled to an optical sensor controller 52 in the I/O subsystem 30. The optical sensor 36 may include a charge-coupled device (CCD) or complementary metal-oxide semiconductor (CMOS) phototransistors. The optical sensor 36 receives light from the environment, projected through one or more lens, and converts the light to data representing an image. In conjunction with appropriate code executing on the processor 18, the optical sensor 36 may capture still images and/or video.

The electronic device 10 may also include one or more accelerometers 54. FIG. 1 shows an accelerometer 54 coupled to the peripherals interface 20. Alternately, the accelerometer 54 may be coupled to an input controller 46 in the I/O subsystem 30. In some embodiments, information is displayed on the display 12 in a portrait view or a landscape view based on an analysis of data received from the one or more accelerometers (e.g., based upon a position in which the electronic device 10 is presently oriented).

In some embodiments, the software components stored in storage/memory 14 may include an operating system, a communication module (or set of instructions), a contact/motion module (or set of instructions), a graphics module (or set of instructions), as well as any other suitable modules or instructions used in the operation of the device 10 or by interfaces or applications executing on the device 10. By way of example, an operating system may be based upon various software platforms, such as Darwin, RTXC, LINUX®, UNIX®, OS X, WINDOWS®, or an embedded operating system such as VxWorks, and may include various software components and/or drivers for controlling and managing general system tasks (e.g., memory management, storage device control, power management, etc.) and facilitates communication between various hardware and software components.

In addition, the software components stored in storage/memory 14 may include various applications and media (e.g., music, videos, e-books) loaded or purchased by a user of the device 10 to provide additional functionality to the device 10. By way of example only, the storage/memory 14 may be configured to store applications and media purchased and/or downloaded from the App Store® or from iTunes®, both of which are online services offered and maintained by Apple Inc.

The communication module facilitates communication with other devices over one or more external ports 34 and also includes various software components for handling data received by the RF circuitry 22 and/or the external port 34. The external port 34 (e.g., Universal Serial Bus (USB), IEEE-1394 (FireWire), Ethernet port, etc.) is adapted for coupling directly to other devices or indirectly over a network (e.g., the Internet, wireless LAN, etc.). In some embodiments, the external port 34 is a multi-pin (e.g., 30-pin) connector that is the same as, or similar to and/or compatible with the 30-pin connector used on iPod® devices.

The contact/motion module may facilitate the detection and/or interpretation of contact with a touch sensitive input device, such as a touch screen, click wheel or touch pad. The contact/motion module includes various software components for performing various operations related to detection of contact, such as determining if contact has occurred (e.g., detecting a finger-down event), determining if there is movement of the contact and tracking the movement across the touch-sensitive surface (e.g., detecting one or more finger-dragging events), and determining if the contact has ceased (e.g., detecting a finger-up event or a break in contact). Determining movement of the point of contact, which is represented by a series of contact data, may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multi-touch”/multiple finger contacts).

The graphics module includes various known software components for rendering and displaying graphics on the display 12 or other connected displays or projectors, including components for changing the intensity of graphics that are displayed. As used herein, the term “graphics” includes any object that can be displayed to a user. In some embodiments, the graphics module stores data representing graphics to be used. Each graphic may be assigned a corresponding code. The graphics module receives, from applications etc., one or more codes specifying graphics to be displayed along with, if necessary, coordinate data and other graphic property data, and then generates screen image data to output to the display controller 44.

Examples of applications that may be stored in storage/memory 14 may include work productivity applications as well as other applications. Examples of such applications may include word processing applications, image editing applications, drawing applications, presentation applications, JAVA-enabled applications, encryption, digital rights management, voice recognition, and voice replication.

With the foregoing discussion of the functional and structural components of an electronic device 10 in mind, FIGS. 2 and 3 depict examples of how such a device 10 may be implemented in practice. For example, FIG. 2 depicts an electronic device 10 in the form of a laptop computer 60. As shown in FIG. 2, the electronic device 10 in the form of a laptop computer 60 includes a housing 62 that supports and protects interior components, such as processors, circuitry, and controllers, among others. The housing 62 also allows access to user input devices 32, such as a keypad, touchpad, and buttons, that may be used to interact with the laptop computer 60. For example, the user input devices 32 may be manipulated by a user to operate a GUI and/or applications running on the laptop computer 60.

The electronic device 10 in the form of the laptop computer 60 also may include various external ports 34 that allow connection of the laptop computer 60 to various external devices, such as a power source, printer, network, or other electronic device. For example, the laptop computer 60 may be connected to an external projector through a cable connected to a respective external port 34 of the laptop computer 60.

In addition to computers, such as the depicted laptop computer 60 of FIG. 2, an electronic device 10 may take other forms, such as a portable multi-function device 70 (e.g., a cellular telephone or a tablet computing device) as depicted in FIG. 3. It should be noted that while the depicted multi-function device 70 is provided in the context of a tablet computing device, other types of portable or handheld devices (such as cellular telephones, media players for playing music and/or video, a camera or video recorder, personal data organizers, handheld game platforms, and/or combinations of such devices) may also be suitably provided as the electronic device 10. Further, a suitable multi-function device 70 may incorporate the functionality of more than one of these types of devices, such as a device that incorporates the functionality of two or more of a media player, a cellular phone, a gaming platform, a personal data organizer, and so forth. For example, in the depicted embodiment, the multi-function device 70 is in the form of a tablet computer that may provide various additional functionalities (such as the ability to take pictures, record audio and/or video, listen to music, play games, and so forth).

In the depicted embodiment, the handheld device 70 includes an enclosure or body 72 that protects the interior components from physical damage and shields them from electromagnetic interference. The enclosure may be formed from any suitable material such as plastic, metal or a composite material and may allow certain frequencies of electromagnetic radiation to pass through to wireless communication circuitry within the handheld device 70 to facilitate wireless communication.

In the depicted embodiment, the enclosure 72 includes user input structures 32 (such as the depicted button 74 and touch sensitive elements 76 incorporated into display 12 to form a touch screen) through which a user may interface with the device 70. Each user input structure 32 may be configured to help control a device function when actuated. For example, the button 74 may be configured to invoke a “home” screen or menu to be displayed. Other buttons, switches, rockers, and so forth may be provided to toggle between a sleep and a wake mode, to silence a ringer or alarm, to increase or decrease a volume output, and so forth.

In the depicted embodiment, the multi-function device 70 includes a display 12 that may be used to display a graphical user interface (GUI) 80 that allows a user to interact with the multi-function device 70. Generally, the GUI 80 may include graphical elements that represent applications and functions of the multi-function device 70. For instance, the GUI 80 may include various layers, windows, screens, templates, or other graphical elements that may be displayed in all, or a portion, of the display 12. Such graphical elements may include icons 82 and other images representing buttons, sliders, menu bars, and the like. The icons 82 may be selected and/or activated via touching their locations on the display 12 in embodiments in which the display 12 is provided as a touch screen.

In the depicted embodiment, an operating system GUI 80 may include various graphical icons 82, each of which may correspond to various applications that may be opened or executed upon detecting a user selection (e.g., via keyboard, mouse, touch screen input, voice input, etc.). The icons 82 may be displayed in a graphical dock 86 or within one or more graphical window elements 84 displayed on the screen of the display 12. By way of example only, the depicted icons 82 may represent a presentation application 88, such as Keynote® from Apple Inc., an application 90 for accessing the App Store® service from Apple Inc., an application 92 for accessing the iTunes® service from Apple Inc., as well as an e-reader/e-book application 94.

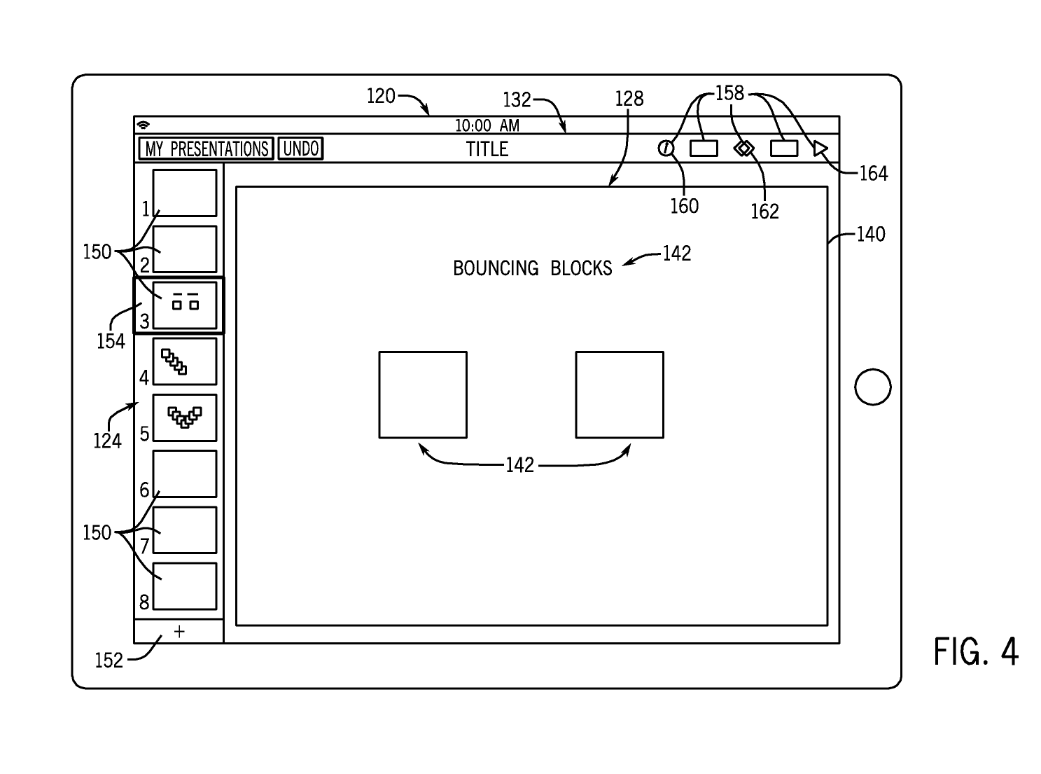

In some embodiments, the selection of a particular icon 82 may lead to a hierarchical navigation process, such that selection of an icon 82 leads to a screen or opens another graphical window that includes one or more additional icons 82 or other GUI elements. By way of example only, the operating system GUI 52 displayed in FIG. 4 may be from a version of the Mac OS® operating system, available from Apple Inc.

The multi-function device 70 also may include various external ports 34 that allow connection of the multi-function device 70 to external devices, such as computers, projectors, modems, telephones, external storage devices, and so forth. For example, one external port may be a port that allows the transmission and reception of data or commands between the multi-function device 70 and another electronic device, such as a computer. One or more of external ports 34 may be a proprietary port from Apple Inc. or may be an open standard I/O port.

With the foregoing discussion in mind, various techniques and algorithms for implementing aspects of the present disclosure on electronic devices 10 and associated hardware and/or memory devices are discussed below. For example, in certain implementations, an electronic device 10 may be employed to store and/or run a work productivity application or suite of applications. One example of such applications includes the Pages® word processing application, the Numbers® spreadsheet application, and the Keynote® presentation application (e.g., 88), which are all provided within the iWork® application suite available from Apple Inc. of Cupertino, Calif. In certain embodiments, such applications, or aspects of such applications, may be encoded using a suitable object-oriented programming language, such as Objective-C, C++, C#, and so forth.

By way of example, a presentation application 88, such as Keynote® may be employed to generate and present slideshows, typically consisting of a sequential display of prepared slides. For example, turning to FIG. 4, an illustrative screen 120 of a presentation application 88 is depicted in accordance with one embodiment of the disclosure. Such a presentation application may be stored as one or more executable routines in storage/memory 14 (FIG. 1) and, when executed, may cause the display of screens, such as screen 120, on a display 12, such as a display configured for use as a touch screen.

Prior to discussing the use or features of a presentation application 88 in accordance with the present disclosure, it should be appreciated that, as used herein, a “slide” should be understood to refer to a discrete unit on which one or more objects may be placed and arranged. Such slides should also be understood to be discrete units or elements of an ordered or sequential presentation, i.e., the slides are the pieces or units that are assembled and ordered to generate the presentation. Such a slide may be understood to function as a container or receptacle for a set of objects (as discussed below) that together convey information about a particular concept or topic of the presentation. A slide may contain or include different types of objects (e.g., text, numbers, images, videos, charts, graphs, and/or audio, and so forth) that explain or describe a concept or topic to which the slide is directed and which may be handled or manipulated as a unit due to their being associated with or contained on the slide unit.

The order or sequence of the slides in a presentation or slideshow is typically relevant in that the information on the slides (which may include both alphanumeric (text and numbers) and graphical components) is meant to be presented or discussed in order or sequence and may build upon itself, such that the information on later slides is understandable in the context of information provided on preceding slides and would not be understood or meaningful in the absence of such context. That is, there is a narrative or explanatory flow associated with the ordering or sequence of the slides. As a result, if presented out of order, the information on the slides may be unintelligible or may otherwise fail to properly convey the information contained in the presentation. This should be understood to be in contrast to more simplistic or earlier usages of the term “slide” and “slideshow” where what was typically shown was not a series of multimedia slides containing sequentially ordered content, but projected photos or images which could typically be displayed in any order without loss of information or content.

As used herein, the term “object” may refer to any individually editable component on a slide of a presentation. That is, something that can be added to a slide and/or be altered or edited on the slide, such as to change its location, orientation, size, opacity, color, or to change its content, may be described as an object. For example, a graphic, such as an image, photo, line drawing, clip-art, chart, table, which may be provided on a slide, may constitute an object. Likewise, a character or string of characters may constitute an object. Likewise, an embedded video or audio clip may also constitute an object that is a component of a slide. Therefore, in certain embodiments, characters and/or character strings (alphabetic, numeric, and/or symbolic), image files (.jpg, .bmp, .gif, .tif, .png, .cgm, .svg, .pdf, .wmf, and so forth), video files (.avi, .mov, .mp4, .mpg, .qt, .rm, .swf, .wmv, and so forth) and other multimedia files or other files in general may constitute “objects” as used herein. In certain graphics processing contexts, the term “object” may be used interchangeably with terms such as “bitmap” or texture”.

Further, because a slide may contain multiple objects, the objects on a slide may have an associated z-ordering (e.g., depth) characterizing how the objects are displayed on the slide. That is, to the extent that objects on the slide may overlap or interact with one another, they may be ordered, layered or stacked in the z-dimension with respect to a viewer (i.e., to convey depth) such that each object is ordered as being above or beneath the other objects as they appear on the slide. As a result, in the event of an overlap of objects, a higher object can be depicted as overlying or obscuring a lower object. In this way, a slide may not only have a width and length associated with it, but also a depth (i.e., a z-axis).

Thus, as used herein, the term “slide” should be understood to represent a discrete unit of a slideshow presentation on which objects may be placed or manipulated. Likewise, an “object,” in this context, should be understood to be any individually editable component that may be placed on such a slide. Further, as used herein, the term “transition” describes the act of moving from one slide to the next slide in a presentation. Such transitions may be accompanied by animations or effects applied to one or both of the incoming and outgoing slide. Likewise, the term “build” as used herein should be understood as describing effects or animations applied to one or more objects provided on a slide or, in some instances to an object or objects that are present on both an outgoing and incoming slide. For example, an animation build applied to an object on a slide may cause the object to be moved and rotated on the slide when the slide is displayed. Likewise, an opacity build applied to an object on a slide may cause the object to fade in and/or fade out on the slide when the slide is displayed. Further, while “objects” are depicted herein as being editable components on a slide of a presentation application 88, it will be appreciated that objects may also refer to editable components of other types of applications, such as word processing applications, spreadsheet applications, image processing/editing applications, and so forth.

With the foregoing in mind, it will be appreciated that, in certain embodiments a presentation application 88, as shown in FIG. 4, may provide multiple modes of operation, such as an edit mode, an animation mode, a presentation or play mode, and so forth. When in the edit mode, the presentation application 88 may provide an interface for a user to add, edit, remove, or otherwise modify the slides of a slide show, such as by adding text, numeric, graphic, or video objects to a slide. Likewise, when in the animation mode, the presentation application 88 may provide an interface for a user to apply and/or modify animation or effects applied to slide transitions between slides or to builds (e.g., animations, effects, and so forth) applied to objects on a slide. To display a created slide or a sequence of slides in a format suitable for audience viewing, a presentation mode of the presentation application 88 may be employed which displays the slides, slide transitions, and object builds in a specified sequence. In some embodiments, the presentation application 88 may provide a full-screen presentation of the slides in the presentation mode, including any animations, transitions, builds or other properties defined for each slide and/or object within the slides.

As will be appreciated, depending on the inputs and selections made by a user, the depicted presentation application 88 may display various screens, icons, and or other graphics. These elements may represent graphical and virtual elements, such as menus, graphical buttons, sliders, dials, scrollbars, and the like, through which the user may manipulate or select to interact with the presentation application 88. Further, it should also be understood that the functionalities set forth and described in the subsequent figures may be achieved using a wide variety graphical elements and visual schemes. Therefore, the present disclosure is not intended to be limited to the precise user interface conventions depicted herein. Rather, embodiments of the present technique may include a wide variety of user interface styles.

The screen 120 of FIG. 4 represents a screen that may be displayed when one embodiment of a presentation application 88 is in an edit mode, such as for slide creation and/or modification. In the depicted example, the screen 120 includes three panes: a slide organizer or navigator pane 124, a slide canvas 128, and a toolbar 132 for creating and editing various aspects of a slide 140 of a presentation. By using these panes, a user may select a slide 140 of a presentation, add objects 142 to and/or edit objects 142 on the slide 140 (such as the depicted graphic objects and character objects), and animate or add effects related to the slide or the objects 142 on the slide 140. While the canvas 128 is depicted herein as being a slide canvas for the presentation application 88, in other embodiments, the canvas 128 may also be a blank document within a word processing application (e.g., Pages® from Apple Inc.), a workbook and/or spreadsheet within a spreadsheet application (e.g., Numbers® from Apple Inc.), or an image editing canvas in an image editing application (e.g., Aperture® from Apple Inc.).

The navigator pane 124 may display a representation 150 of each slide 140 of a presentation that is being generated or edited. The slide representations 150 may take on a variety of forms, such as an outline of the text in the slide 140 or a thumbnail image of the slide 140. Navigator pane 124 may allow the user to organize the slides 140 prepared using the application. For example, the user may determine or manipulate the order in which the slides 140 are presented by dragging a slide representation 150 from one relative position to another. In certain embodiments, the slides representations 150 in the navigator pane 124 may be indented or otherwise visually set apart for further organizational clarity. In addition, in certain embodiments, the navigator pane 124 may include an option 152 which, when selected, adds a new slide to the presentation. After being added, the slide representation 150 for such a new slide may be selected in the navigator pane 124 to display the slide 140 on the canvas 128 where objects 142 may be added to the new slide 140 and/or the properties of the new slide 140 may be manipulated.

In certain implementations, selection of a slide representation 150 in the navigator pane 124 results in the presentation application 88 displaying the corresponding slide information on the slide canvas 128. For example, for a selected slide representation (here depicted as the slide numbered 3 (“slide 3”), as identified by highlighted region 154) the corresponding slide 140 may be displayed on the slide canvas 128. The displayed slide 140 may include one or more suitable objects 142 such as, for example, text, images, graphics, video, or any other suitable object. In some embodiments, a user may add or edit features or properties of a slide 140 when displayed on the slide canvas 128, such as slide transitions, slide background, and so forth. In addition, in some embodiments a user may add objects 142 to or remove objects 142 from the slide 140 or may manipulate an object 142 on the slide 140, such as to change the location or appearance of the object 142 or to add or edit animations or builds to the object 142. The user may select a different slide 140 to be displayed for editing on slide canvas 124 by selecting a different slide representation 150 from the navigator pane 124, such as by touching the displayed slide representation 150 in a touch screen embodiment of the device 10.

In the depicted implementation a user may customize objects 142 associated with the slide 140 or the properties of the slide 140 using various tools provided by the presentation application 88. For example, in certain embodiments, when in the edit mode, selection of a slide 140, object 142, and/or toolbar option 158 may cause the display of an interface presenting one or more selectable options for the selected slide 140 or object 142, which a user may then select, deselect, or otherwise manipulate to modify the slide 140 or object 142 as desired. For example, selection of certain toolbar options 158, such as an inspector or information icon 160, may cause properties of the selected object 142 or slide 140 to be displayed for review and/or modification. Likewise, selection of an animation mode icon 162 from among the toolbar options 158 may cause the presentation application 88 to enter an animation mode from which builds or animations applied to objects and/or transitions assigned to slides may be reviewed, edited, and/or manipulated. Similarly, selection of a play mode icon 164 from among the toolbar options 158 may cause the presentation application 88 to enter a presentation mode in which the slides 140 of the slide presentation are sequentially displayed on the display 12 or an attached display device.

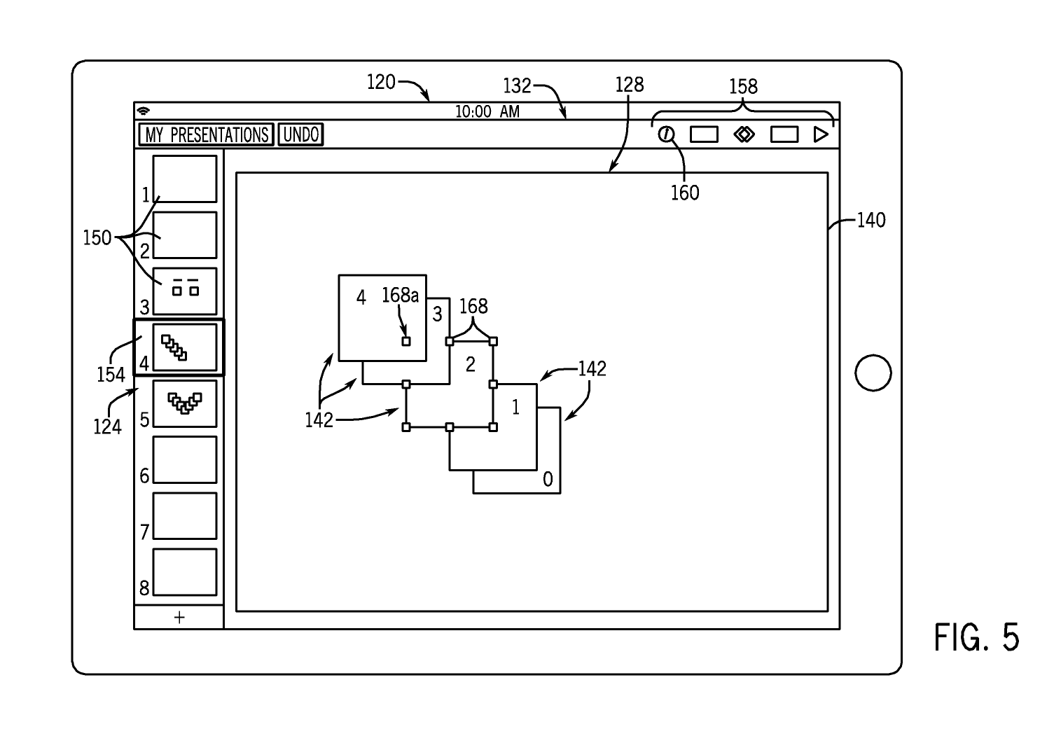

As discussed above, certain aspects of the present disclosure relate to techniques for controlling the z-ordering of selected objects within a slide of a presentation. Certain embodiments of such techniques will now be discussed below with reference to FIGS. 5-25. Those skilled in the art will readily appreciate that the detailed description given herein with respect to these figures is merely intended to provide, by way of example, certain forms that embodiments of the present technique may take. That is, the disclosure should not be construed as being limited only to the specific embodiments discussed herein.

Referring first to FIGS. 5-13, techniques for adjusting the z-ordering of a single selected object from a group of objects within a slide is illustrated. For instance, as shown in FIG. 5, the screen 120 depicts the selection by a user of a different slide representation 150, here the slide numbered 4 (“slide 4”), within the navigation panel 124 of the presentation application 88. As a result of the user selection, the selected slide becomes highlighted, as shown by the highlighted region 154, and the corresponding slide 140 is displayed on the slide canvas 128.

The current slide 140 includes five objects 142, each taking the form of a geometric square block, although any suitable type of objects 142 may be present, such as text, images, video, charts, tables, and so forth. Each of the objects 142 may have a horizontal and vertical position with respect to the screen 120, sometimes referred to as x-y coordinates. Each of the depicted objects 142 may also have an associated z-ordering position that enables a user to differentiate the depth of each object 142. For instance, in the present example, the z-order positions of each object may be expressed from 0 to n−1, wherein n represents the total number of objects 142 within the slide having unique z-order positions, and wherein a z-order position of 0 represents the object having the greatest depth. That is, an object 142 having a z-order position of 0 may be perceived by a user as being beneath all the other objects 142. In other words, in the present embodiments, the z-order position may increase in the perpendicular direction (e.g., along a z-axis) outwards from the plane of the screen 120. To better illustrate the z-order positions of each object 142 in FIG. 5, each geometric block is labeled with its associated initial z-order position. Thus, the five objects 142, when listed in order from the lowest z-order position to the highest z-order position, are: block 0, block 1, block 2, block 3, and block 4, wherein block 0 is beneath each of blocks 1-4, block 1 is beneath blocks 2-4 but above block 0, and so forth.

As further shown in FIG. 5, the edges of block 2 are currently outlined by a set of selection indicators 168. This may indicate that the presentation application 88 has received a request (e.g., via user input) to select block 2 for editing. For instance, the selection of block 2 may be accomplished by selecting block 2 by providing the appropriate inputs via a keyboard, mouse, or other input device or, where the device 10 includes a touch screen display 12, by touching the position of block 2 on the screen 120 using a finger or a stylus. As shown, the selection indicators 168 generally outline the corners and edges of the selected object 142, here block 2. In the presently illustrated embodiment, certain selection indicators, such as 168a, may be visible even though the portion of block 2 over which the selection indicator 168a appears is hidden (e.g., beneath) block 3 and block 4. This allows a user to perceive the general shape of the selected object 142 even if a portion of the selected object (e.g., block 2) is hidden from view by one or more other objects 142.

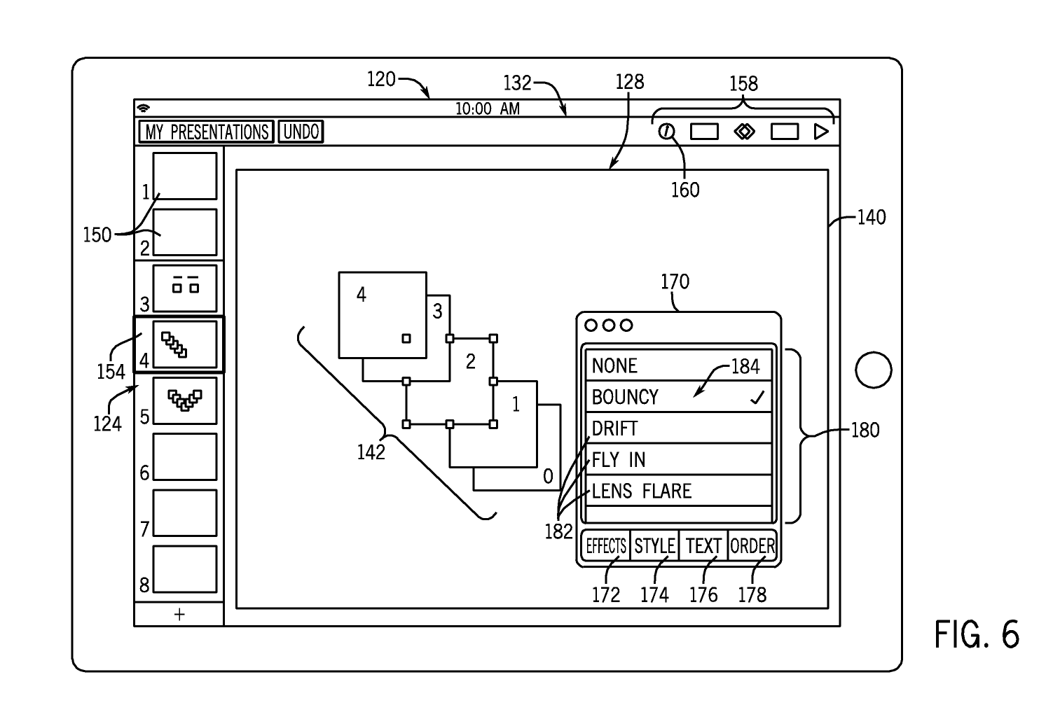

Continuing to FIG. 6, the selection of the inspector or information icon 160 from the toolbar options 158 displayed on the toolbar 132 may cause the graphical window 170 to be displayed within the application canvas 128. The graphical window 172 may enable a user to review, edit, or modify various properties of selected objects. In the present embodiment, the graphical window 170 may include the graphical buttons 172, 174, 176, and 178, each of which may correspond to specific functions. For instance, the graphical button 172 may allow the user to access the listing 180 for selecting and associated animation effects with the selected object, here block 2. The listing 180 may include various items 182, each corresponding to a different animation effect. The user may select one or more animation effects 184 to be associated with the selected object 142 by selecting the desired effects 184 from the listing 180. In this manner, the way in which the selected object (block 2) appears or transitions onto the slide 140 during play mode (e.g., initiated via selection of icon 164) may be configured. The graphical button 174 may allow a user to edit or modify various style options related to the selected object 142, such as shape, color, size, opacity, and so forth. Further, the graphical button 176 may allow a user to add, edit, or modify text associated with and displayed within the selected object.

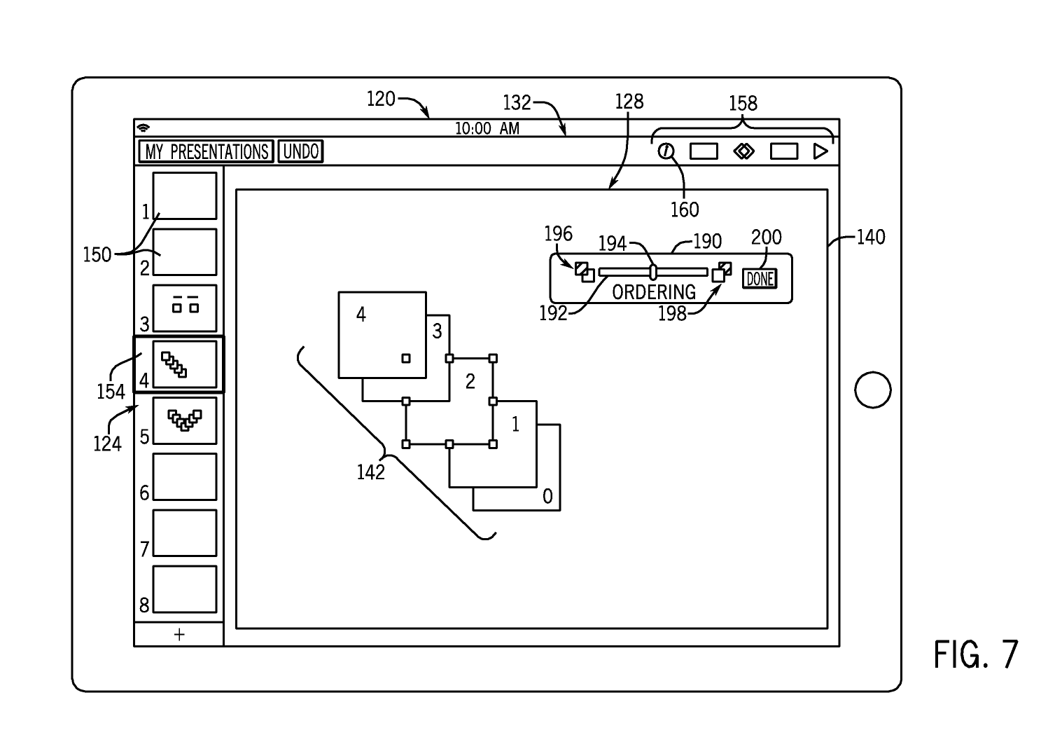

With respect to z-ordering, a user may also modify the z-order position of the selected object (block 2) by selecting the graphical button 178. For instance, referring to FIG. 7, the selection of the graphical button 178 from FIG. 6 may cause the graphical window 190 to be displayed. While FIG. 7 depicts the window 170 as being removed from the screen 120 when the window 190 appears, the window 170 may remain on the screen 120 alongside the window 190 in other embodiments.

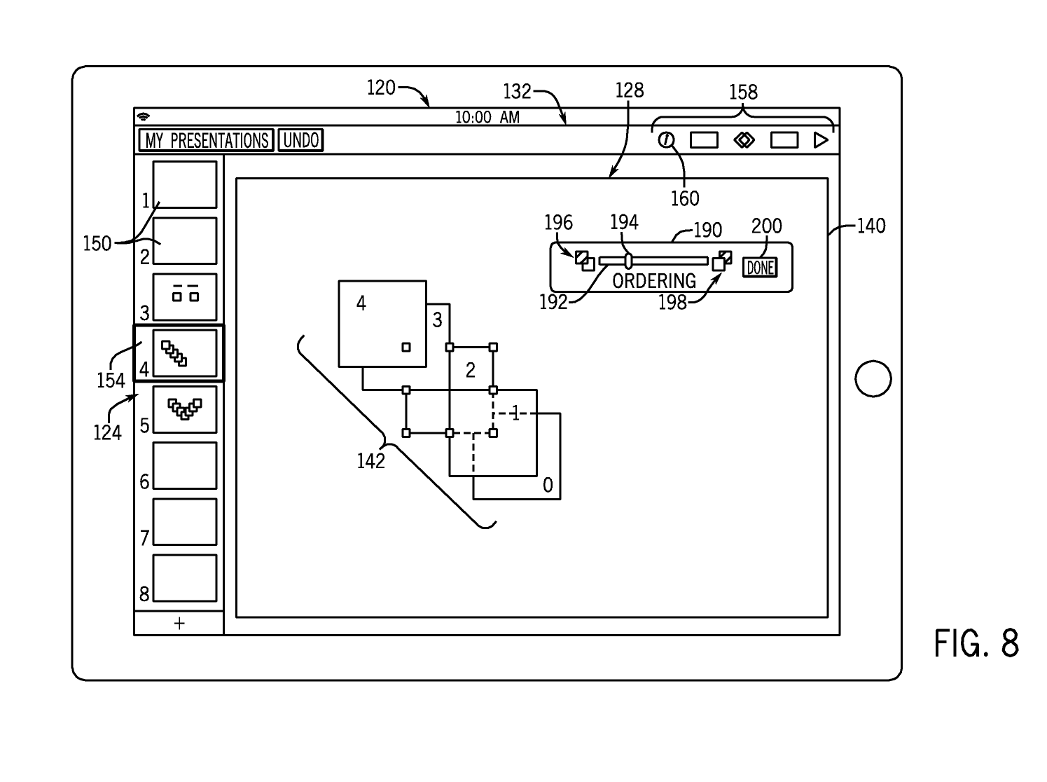

The window 190 includes a graphical slider 192 having a slider indicator 194 that may be manipulated along the slider 192 to change the z-order position of a selected object(s) in response to user inputs. The graphics 196 and 198 may be displayed within the window 190 on opposite ends of the slider 192 to indicate the directions in which the slider indicator 194 may be moved to increase or decrease the z-order position of block 2. For instance, in the present embodiment, sliding the indicator 194 to the left (e.g., towards graphic 196) may reduce the current z-order position of block 2, and sliding the indicator 195 to the right (e.g., towards graphic 198) may increase the current z-order position of block 2. In accordance with embodiments of the present technique, the slide canvas 128 may be updated interactively or dynamically to display the changes in z-ordering of the objects 142 as the user manipulates the position of the indicator 194. In other words, the desired adjustments may be displayed and previewed by the user on the slide canvas 128, although such adjustment may not necessarily be fixed until the user indicates that the z-order editing process is completed. For instance, once the desired z-ordering adjustments have been made, a user may exit the window 190, thus ending the z-ordering editing functionality provided by the presentation application 88, through selection of the graphical button 200 (the “DONE” button). These techniques are depicted in more detail below with respect to FIGS. 8-11.

As shown in FIG. 8, the indicator 194, which may be responsive to user inputs provided via an input device (e.g., keyboard or mouse) or from a touch screen display 12, has been moved in the leftward direction. This causes the z-order position of block 2 to decrease. For instance, while block 2 was initially depicted as having a z-order position greater than block 1 and, therefore overlaying a portion of block 1, the current z-order position of block 2, in response to the z-ordering changes received via the slider 192, has caused block 2 to transition to a z-order position that is beneath block 1 but above block 0, as indicated by the phantom edges of blocks 0 and 2. Thus, the current z-order positions of the objects 142 in FIG. 8 from lowest to highest are: block 0, block 2, block 1, block 3, and block 4.

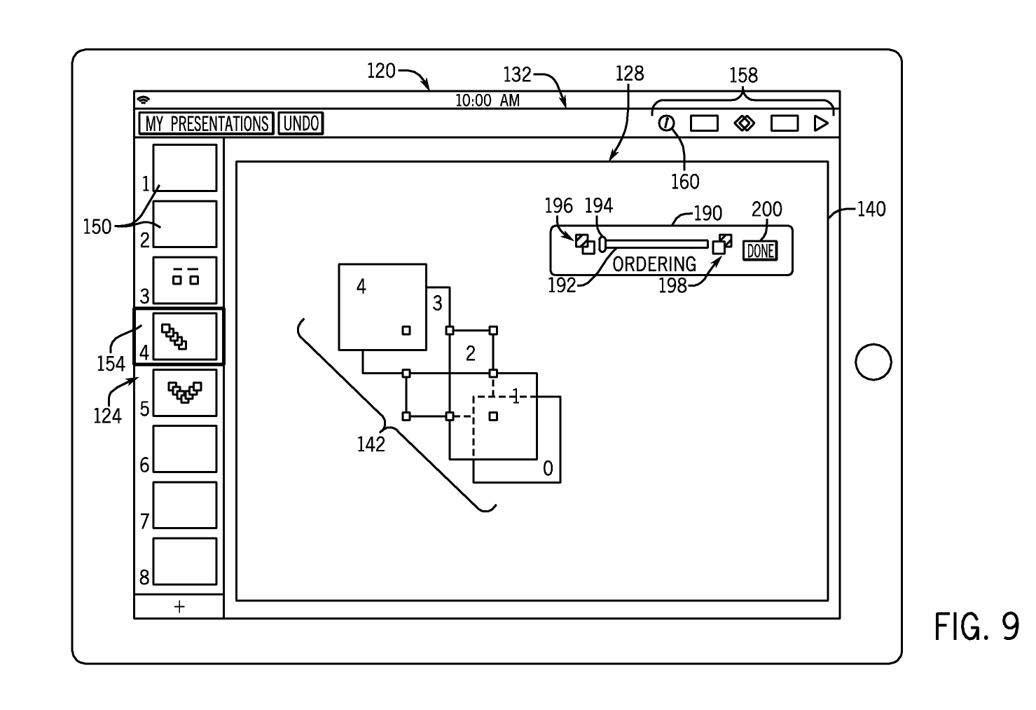

In FIG. 9, the indicator 194 is moved to the leftmost end of the slider 192. This causes the z-order position of block 2 to decrease once again. For instance, based upon the leftmost position of the indicator 194 in FIG. 9, block 2 may transition to the lowest possible z-order position (e.g., beneath block 0, as indicated by the phantom edges of blocks 0 and 2) with respect to the objects 142 on the current slide 140. As such, the current z-order positions of the objects 142 in FIG. 9 are, from lowest to highest: block 2, block 0, block 1, block 3, and block 4.

While FIGS. 8 and 9 appear to show and describe the adjustment of block 2's z-order position in discrete separate steps, it should be understood that such an adjustment may actually be performed in a single step or motion. For instance, the user may slide the indicator 194 from the position shown in FIG. 7 directly to the position shown in FIG. 9 (e.g., leftmost position) without stopping the indicator 194 during the motion. However, the slide canvas 128 may still display the z-ordering of the objects 142, as shown in FIG. 8, as the user moves the indicator 194 from the original position of FIG. 7 towards the leftmost end of the slider 192. In other words, while such a motion may be continuous, the application canvas 128 may still display each step-wise transition in the z-order position of block 2 (e.g., first from z-order position 2 to z-order position 1, and then from z-order position 1 to z-order position 0) during the motion as the indicator 194 moves to and past corresponding positions on the slider 192.

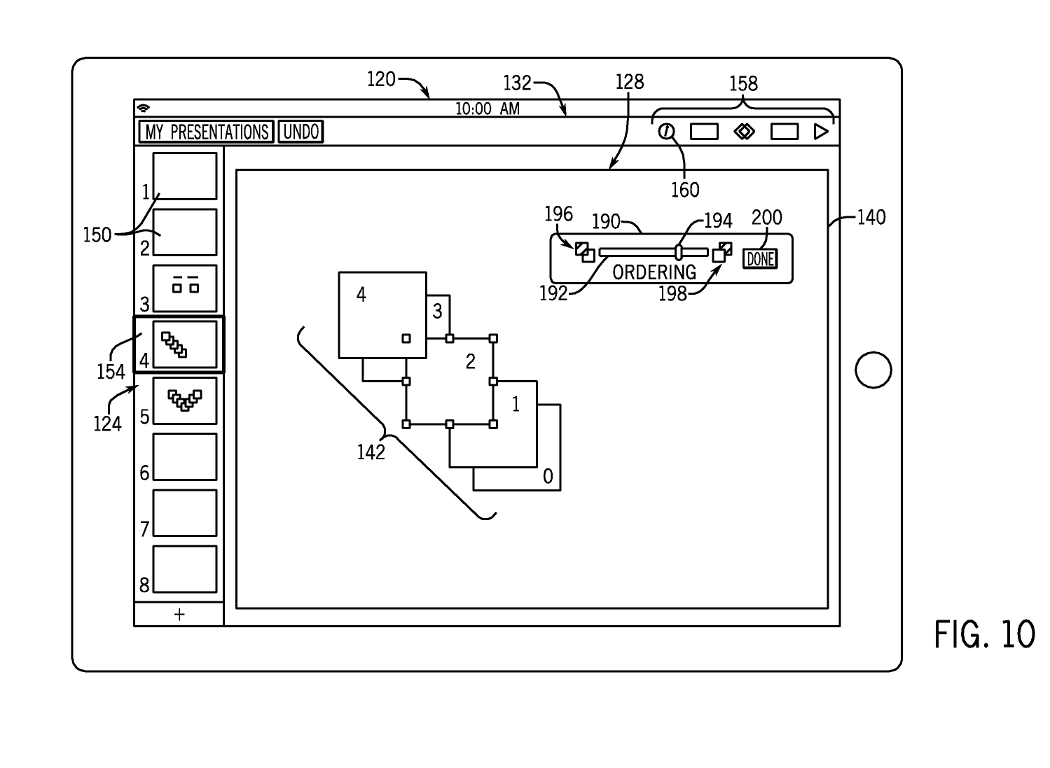

Continuing, FIG. 10 shows the movement of the indicator 194 back towards the right side of the slider 192, thereby causing the z-order position of block 2 to increase. For instance, the current position of the indicator 194 may be obtained by moving the indicator 194 from the leftmost end of the slider 192 (FIG. 9) and towards the right side of the slider 192 past its original position from FIG. 7. This causes the z-order position of block 2 to increase above its original z-order position (FIG. 7), such that block 2 is currently above block 3 and below block 4, and such that the current z-order positions of the objects 142 in FIG. 10 are, from lowest to highest: block 0, block 1, block 3, block 2, and block 4.

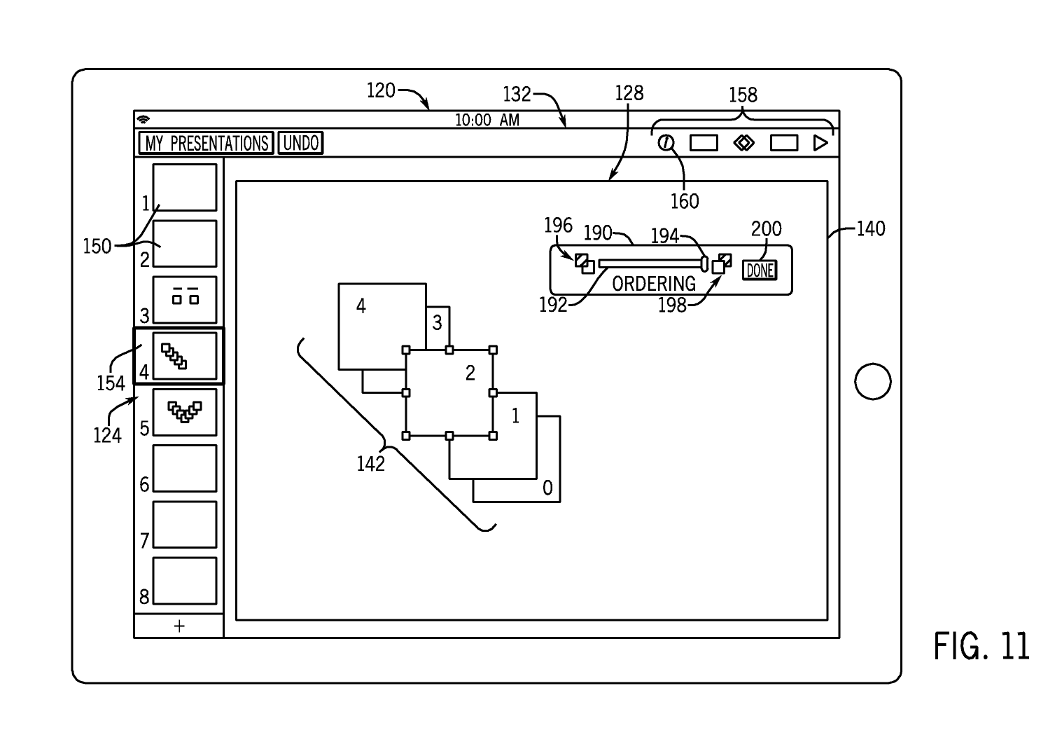

Next, in FIG. 11, the indicator 194 is moved to the rightmost end of the slider 192. This causes the z-order position of block 2 to increase once again. For instance, based upon the rightmost position of the indicator 194 in FIG. 11, block 2 may transition to the greatest possible z-order position (e.g., above block 4) with respect to the other objects 142 of the current slide 140. As such, the current z-order positions of the objects 142 in FIG. 11 are, from lowest to highest: block 0, block 1, block 3, block 4, and block 2. Thus, as shown in FIGS. 7-11, the slider 192 and indicator 194 collectively provide for an interactive graphical adjustment tool for manipulating z-order positions of objects 142 within a slide 140. Further, while the slider 192 is depicted in FIG. 7 as being oriented in the horizontal direction, other embodiments of the slider 192 may include vertically oriented sliders, three-dimensional sliders, and so forth.

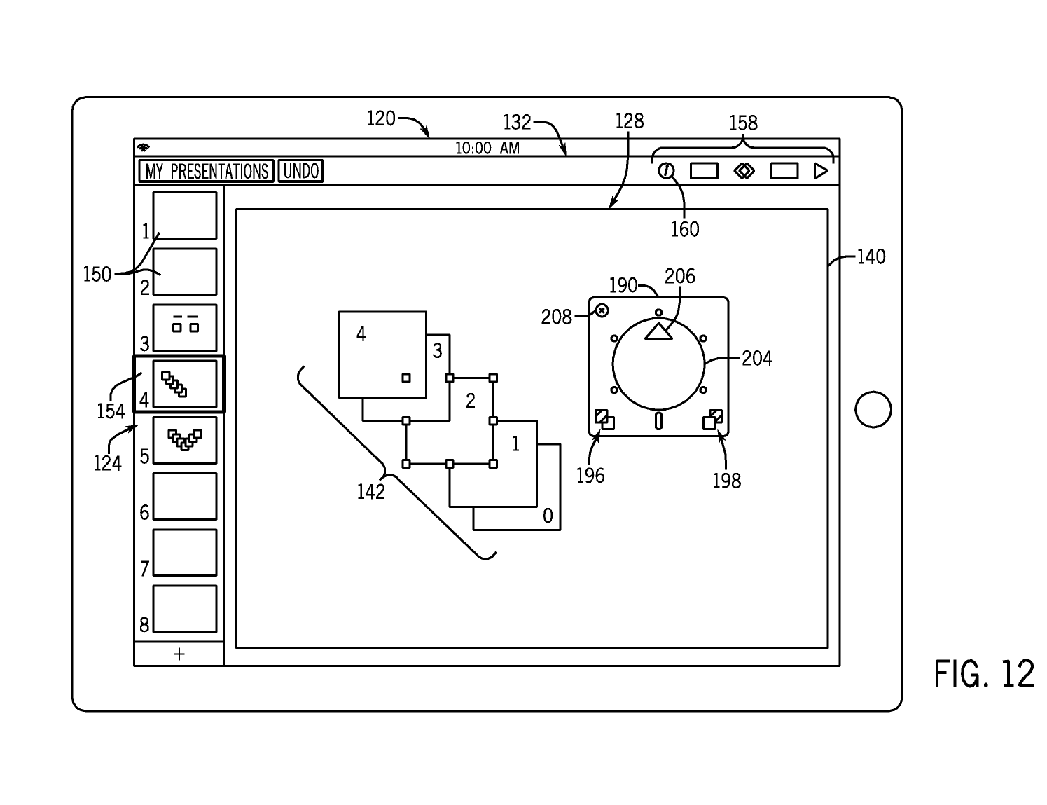

Further, while the adjustment of z-order positions is accomplished in the embodiments shown in FIGS. 5-11 by way of the depicted graphical slider 192 and indicator 194, it should be understood that any suitable type of interactive graphical adjustment tool may be utilized in other embodiments. For instance, referring to FIG. 12, another embodiment of an interactive graphical adjustment tool may be provided by way of a graphical dial or wheel 204 depicted in the window 190. The dial 204 may include an indicator 206 that indicates a current position of the dial 204. In this embodiment, the z-order position of a selected object 142 (e.g., block 2) may be decreased by rotating the graphical dial 204 counterclockwise (towards graphic 196) or may be increased by rotating the graphical dial 204 clockwise (towards graphic 198). Completion of the z-order editing process may be indicated by selecting the graphical button 208. Indeed, those skilled in the art will readily appreciate that a variety of graphical elements may be provided for accomplishing the above-discussed z-order adjustment techniques.

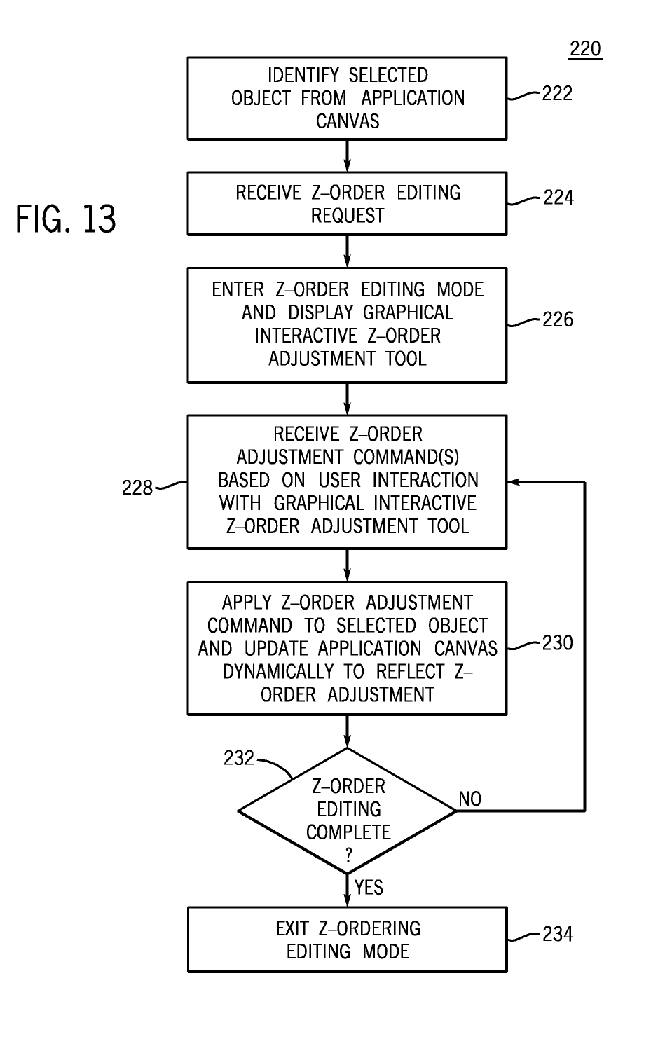

The techniques discussed above with reference to FIGS. 5-12 are further illustrated in FIG. 13 by way of a flowchart depicting a method 220. Beginning at block 222 of the method 220, an object 142 (e.g., block 2) may be selected from a slide 140 displayed within the slide canvas 128 of the screen 120. At block 224 a request to edit z-ordering properties of the selected object is received. For instance, block 224 may correspond to the actions of selecting the inspector icon 160 from the toolbar options 158, and subsequently selecting the graphical button 178 from the graphical window 170, as shown in FIG. 6, to bring up the graphical window 190. The method 220 then proceeds to block 226, wherein the presentation application 88 enters a z-ordering editing mode and a graphical interactive tool (e.g., combination of slider 192 and indicator 194) is provided to a user for making z-ordering adjustments.

At block 228, one or more z-order adjustment commands may be received based upon user inputs provided via the graphical interactive tool. Next, at block 230, the received commands are applied to the selected object or objects by updating the slide 140 displayed within the slide canvas 128 as a dynamic preview to reflect the z-order adjustments requested by the user. Thereafter, at decision block 232, the method 220 determines whether the z-order editing process is completed. For instance, the method 220 may detect the completion of the z-order editing process based on whether the user selects the DONE button 200 from the window 190 (or the graphical button 208 in the embodiment illustrated in FIG. 12). If the user does not indicate that z-order editing is completed, the method 220 returns from decision block 232 to block 228 to receive additional z-order adjustment commands. If, at decision block 232, it is determined that the z-order editing process is completed, then the method 220 ends at block 234, in which the z-order editing mode is exited (e.g., the window 190 is closed by the presentation application 88).

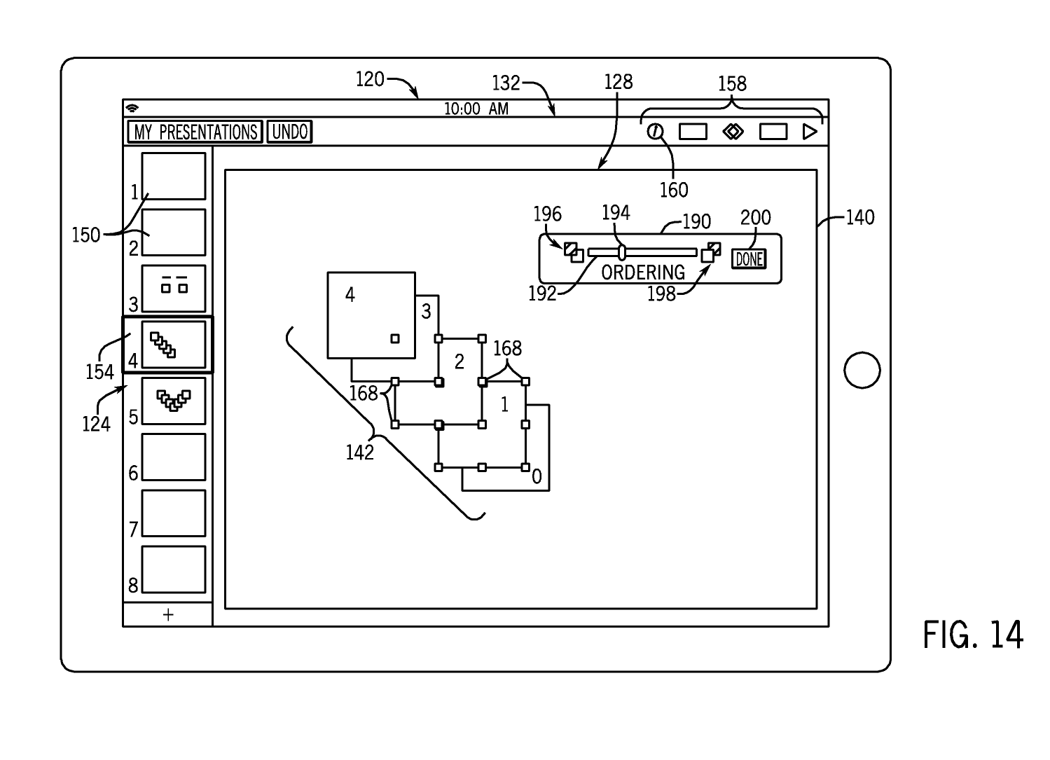

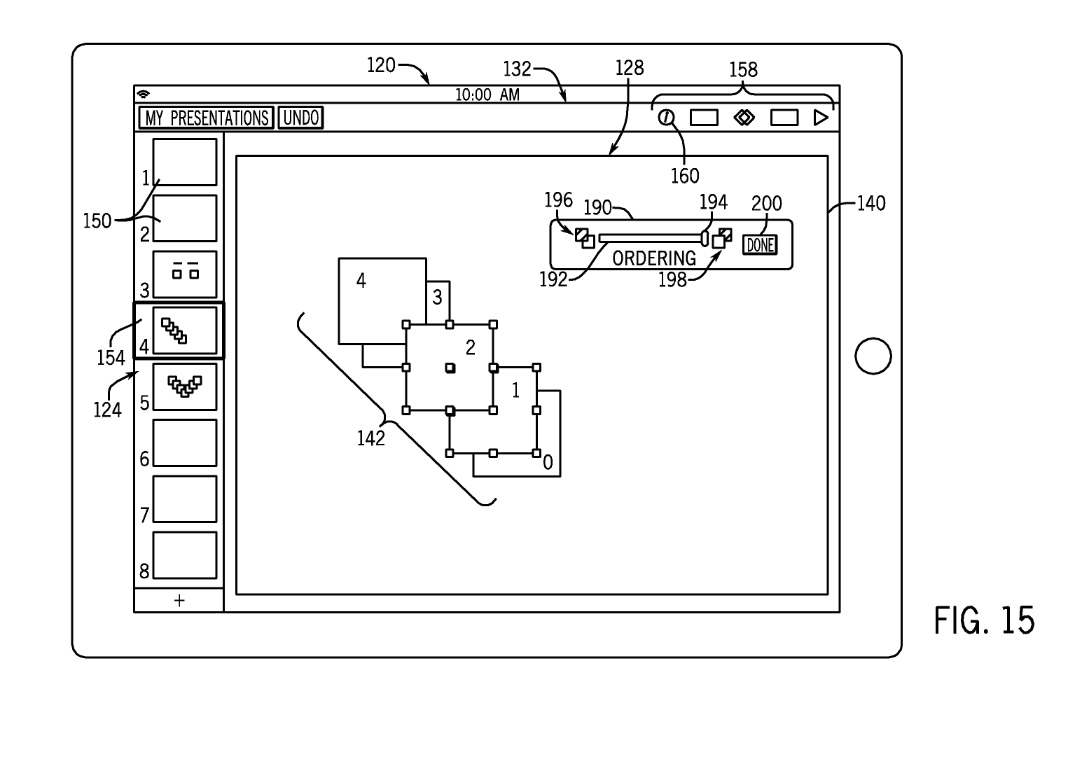

While the embodiments illustrated in FIGS. 5-12 generally depict z-ordering control with respect to a single selected object (e.g., block 2), the present technique is also applicable to the adjustment the z-order positions for multiple concurrently selected objects 142. For instance, FIGS. 14 and 15 illustrate an embodiment in which the z-ordering for multiple contiguous selected objects (e.g., objects having z-order positions that are directly adjacent) is adjusted. As shown in FIG. 14, the illustrated objects 142 are initially arranged in a manner similar to FIG. 7, such that the z-order positions of the objects 142, listed in order from lowest to highest are: block 0, block 1, block 2, block 3, and block 4.

The multiple contiguous selected objects 142 in FIG. 14 are blocks 1 and 2, whereby block 1 has a z-order position that is directly adjacent (e.g., beneath) block 2. FIG. 15 depicts a z-order adjustment of blocks 1 and 2, which is updated dynamically or interactively on the canvas 128, in which the indicator 194 of the slider 192 is moved from the position shown in FIG. 14 to the rightmost position shown in FIG. 15. This may cause both of the blocks 1 and 2 to increase in z-order position, while maintaining their relative z-ordering with respect to one another. That is, while the z-order positions of each block 1 and 2 may change based upon the user inputs, block 2 will maintain a z-order position that is greater relative to the z-order position of block 1. In the depicted embodiment, the contiguous arrangement of the selected objects is also maintained.

Further, as discussed above, because the adjustment of the indicator 194 may indicate a user's desire to shift the selected objects (blocks 1 and 2) to the highest possible z-order positions, the order of the objects 142 listed from lowest to highest z-order positions, as shown in FIG. 15, is: block 0, block 3, block 4, block 1, and block 2. As will be appreciated, this represents the greatest possible z-order positions for the selected objects (blocks 1 and 2) with respect to the remaining objects 142, as the presently illustrated embodiment maintains not only the contiguity of blocks 1 and 2, but also their relative z-ordering prior to the adjustment (e.g., block 2 remains above block 1 after the adjustment).

To provide some additional examples with respect to the objects 142 depicted on the slide 140 of FIG. 15, moving the indicator 194 back towards the left end of the slider 192 may decrease the z-order positions of each of the blocks 1 and 2, but such that the blocks 1 and 2 still maintain both their contiguity and relative z-ordering with respect to each other. For instance, moving the indicator 194 slightly towards the left end of the slider 192 may adjust the z-order positions of the objects, from lowest to highest, as follows: block 0, block 3, block 1, block 2, and block 4. Continuing to move the indicator 194 to the leftmost end of the slider 192 may further adjust the z-order positions of the objects, from lowest to highest, as follows: block 1, block 2, block 0, block 3, and block 4. Thus, when the indicator 194 is positioned at the leftmost end of the slider 192, the blocks 1 and 2 are adjusted to the lowest possible z-order positions while maintaining their relative ordering with respect to one another (e.g., block 1 remains beneath block 2).

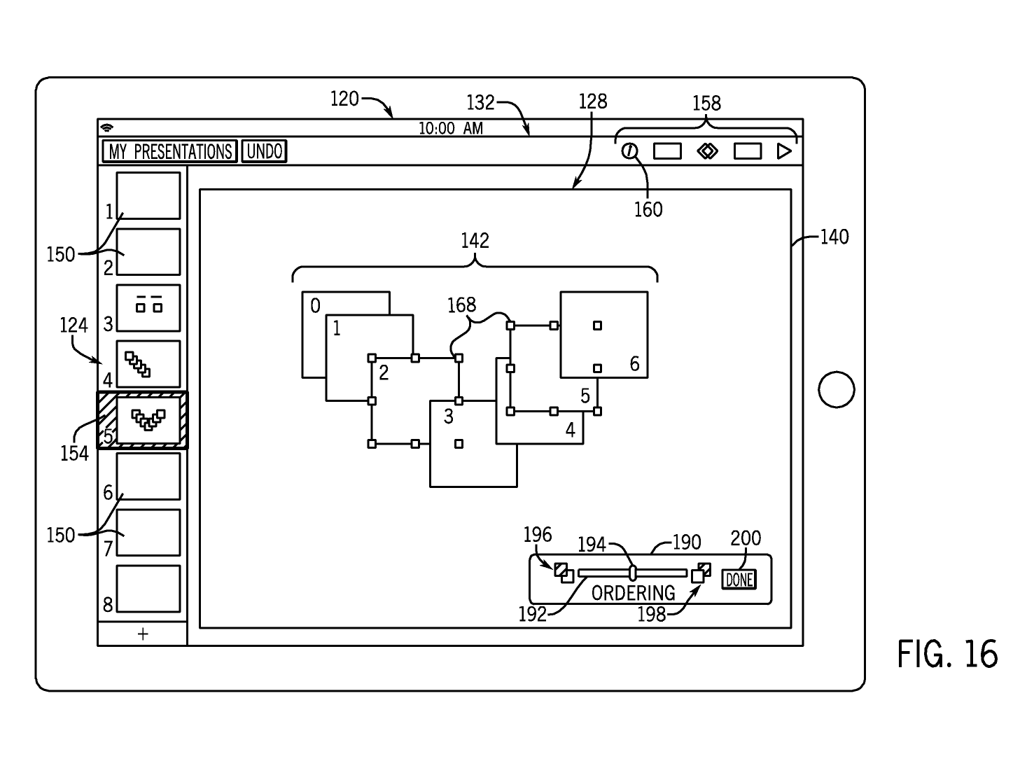

Continuing to FIGS. 16-20, a further embodiment that depicts the z-ordering adjustment of multiple concurrently selected objects 142 within a slide 140 that are not contiguous with respect to one another is illustrated. Referring first to FIG. 16, the screen 120 depicts the selection by a user of a different slide representation 150, here the slide numbered 5 (“slide 5”), within the navigation panel 124 of the presentation application 88. As a result of the user selection, the selected slide 5 becomes highlighted, as shown by the highlighted region 154, to indicate that it is the presently selected slide, and the corresponding slide 140 is displayed within the slide canvas 128.

The current slide 140 includes seven objects 142 in the form of geometrical square blocks although, as discussed above, any suitable type of objects 142 may be present, such as text, images, video, charts, tables, etc. Here, the objects 142 depicted in FIG. 16 are initially arranged such that each object 142 has a unique z-order position, and such that the objects 142, when listed in order from the lowest z-order position to the highest z-order position, include: block 0, block 1, block 2, block 3, block 4, block 5, and block 6. FIG. 16 also indicates that of these seven objects 142, multiple non-contiguous objects, here block 2 and block 5 (as shown by the selection indicator points 168), are presently selected for editing by a user. For instance, the z-order positions of the selected blocks 2 and 5 may be adjusted by moving the position of the indicator 194 on the slider 192.

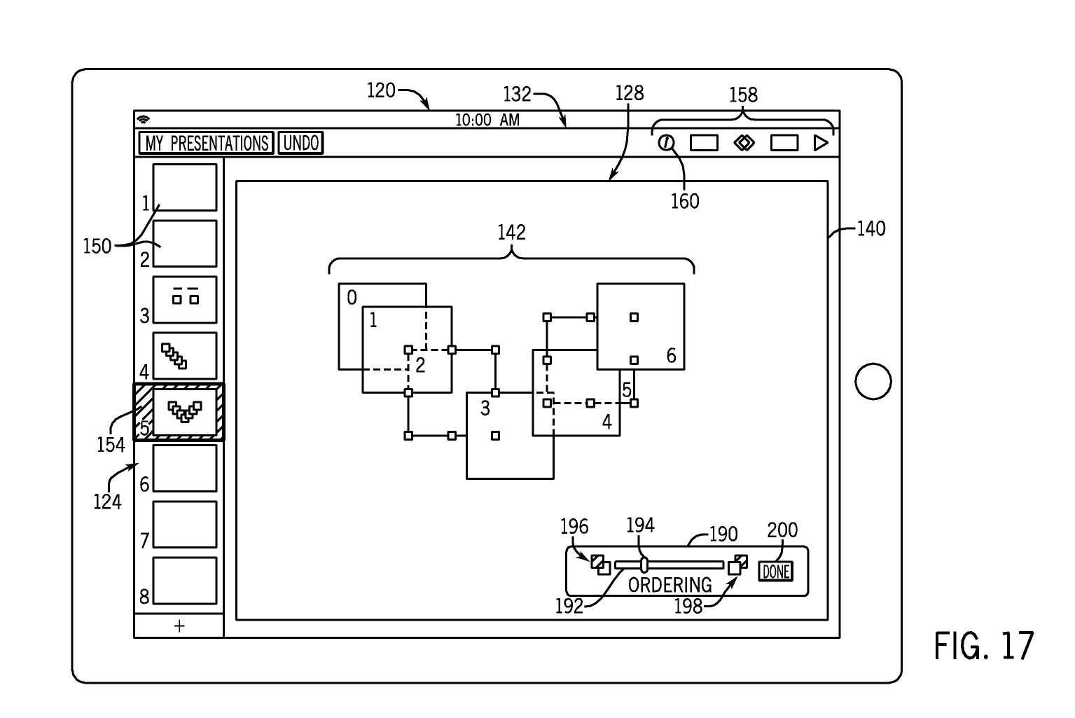

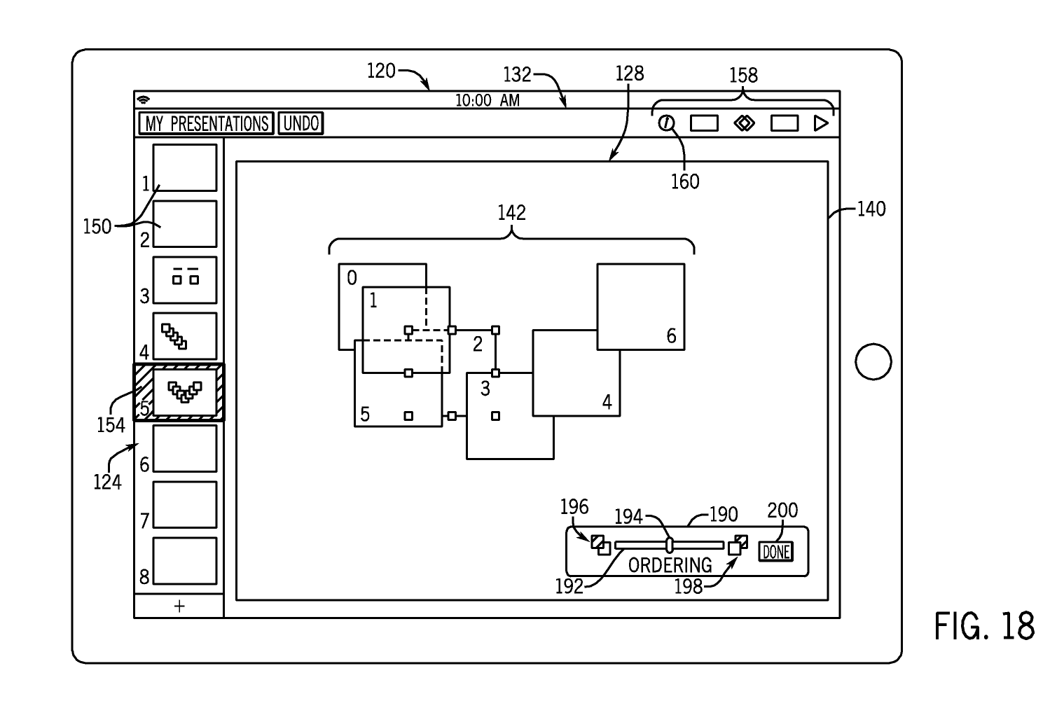

In the present embodiment, adjustment of the z-order positions of multiple concurrently selected non-contiguous objects from within the slide 140 may result in the multiple selected objects (blocks 2 and 5) becoming contiguous while retaining their relative z-ordering with respect to one another. For instance, with respect to the selected blocks 2 and 5, a user input that increases or decreases the z-order positions of blocks 1 and 5, which are currently separated or spaced by two z-order positions or levels (e.g. blocks 3 and 4), may result in blocks 2 and 5 being contiguous in the z-direction while retaining their relative z-ordering from prior to the adjustment, i.e., block 5 having an adjusted z-order position that is directly adjacent but greater relative to the adjusted z-order order position of block 1. This adjustment is illustrated in FIGS. 17 and 18, in which the indicator 194 is moved from its position in FIG. 16 towards the left end of the slider 192, indicating a user request to decrease the z-order positions of the selected blocks 2 and 5. Based upon the position of the indicator 194 in FIG. 17, the z-order position of block 2 is decreased by one z-order level or position, such that block 2 is now beneath block 1. Additionally, the z-order position of block 5 is decreased by three z-order levels, such that block 5 is also beneath block 1 and directly adjacent to block 2.

To better illustrate these relative adjusted positions of blocks 2 and 5, FIG. 18 shows the objects 142 from FIG. 17, but with block 5 moved in the x and y directions (horizontally and vertically) to more clearly show that blocks 2 and 5 are now contiguous in the z-direction and positioned between blocks 0 and 1 while maintaining their relative z-ordering with respect to one another (e.g., block 5 still retains a greater z-order position than block 2). Thus, in order from the lowest z-order position to the highest z-order position in accordance with FIGS. 17 and 18, the objects 142 are arranged as follows: block 0, block 2, block 5, block 1, block 3, block 4, and block 6.

The determination of how to adjust the z-order positions of multiple concurrently selected non-contiguous objects 142 from the slide 140 may be based upon the direction of the z-order adjustment. For instance, in FIGS. 16-18, the direction of the requested z-order adjustment may be identified based on whether the user moves the indicator 194 on the slider 192 to the left (e.g., decrease z-order) or right (e.g., increase z-order). Once the z-order adjustment direction is determined, the selected object having a z-order position that is furthest in that direction is identified as a reference object. For instance with respect to the example illustrated in FIGS. 16-18, because the adjustment direction is in the decreasing z-direction, block 2, which has the lowest z-order position of the selected objects (blocks 2 and 5) becomes the reference object. Similarly, if the user had moved the slider indicator 194 to the right (e.g., indicating an adjustment in the increasing z-direction), then block 5, which has the highest z-order position of the selected objects, becomes the reference object.

Accordingly, during the z-order adjustment, the z-order position of the reference object is adjusted based on the position of the slider indicator 194, while the remaining object or objects are moved as many z-order positions as needed to become contiguous with the reference object after the adjustment. For instance, as discussed with reference to FIG. 17, block 2, which is the reference object, is adjusted such that its z-order position is reduced by one based upon the position of the slider indicator 194, while the z-order position of block 5 is decreased by three z-order positions to be contiguous with block 2. Thus, in the present embodiment, any spacing between the non-contiguous selected objects is not maintained after the z-order adjustment. Further, once the selected blocks become contiguous, as shown in FIG. 17, additional z-order adjustments of the selected objects may be performed in accordance with the techniques illustrated in FIGS. 14 and 15 with respect to the z-order adjustment of contiguous objects. For example, sliding the indicator 194 further to the left may result in the z-order positions of the now contiguous blocks 2 and 5 being decreased, such that block 0 is above each of these blocks.

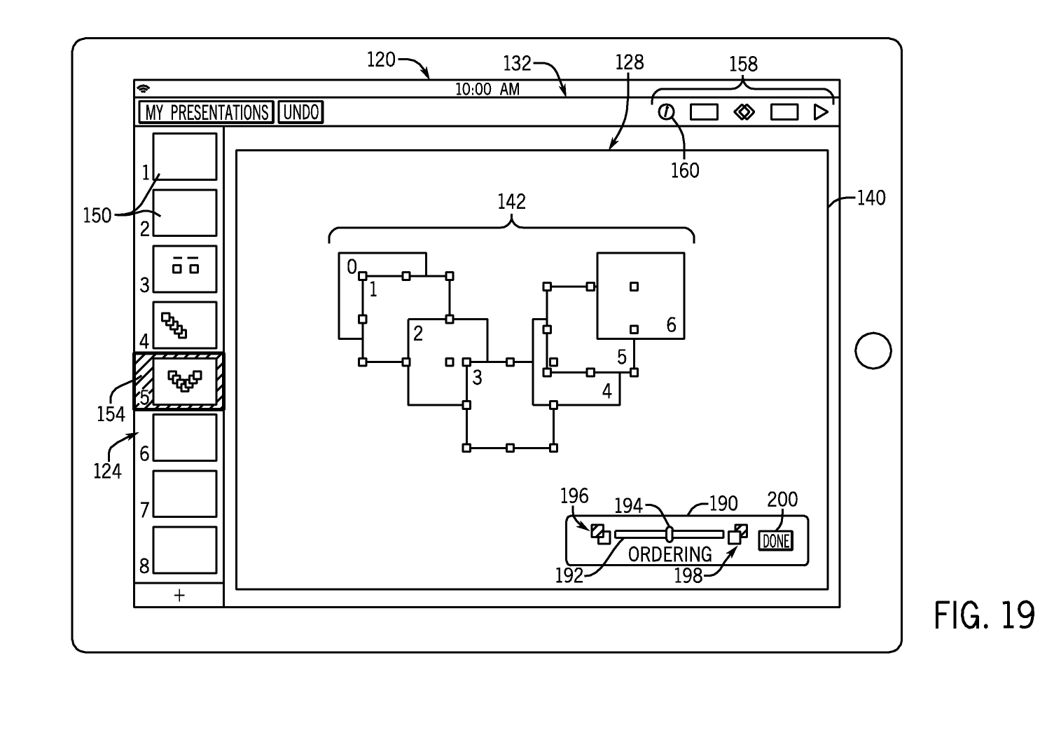

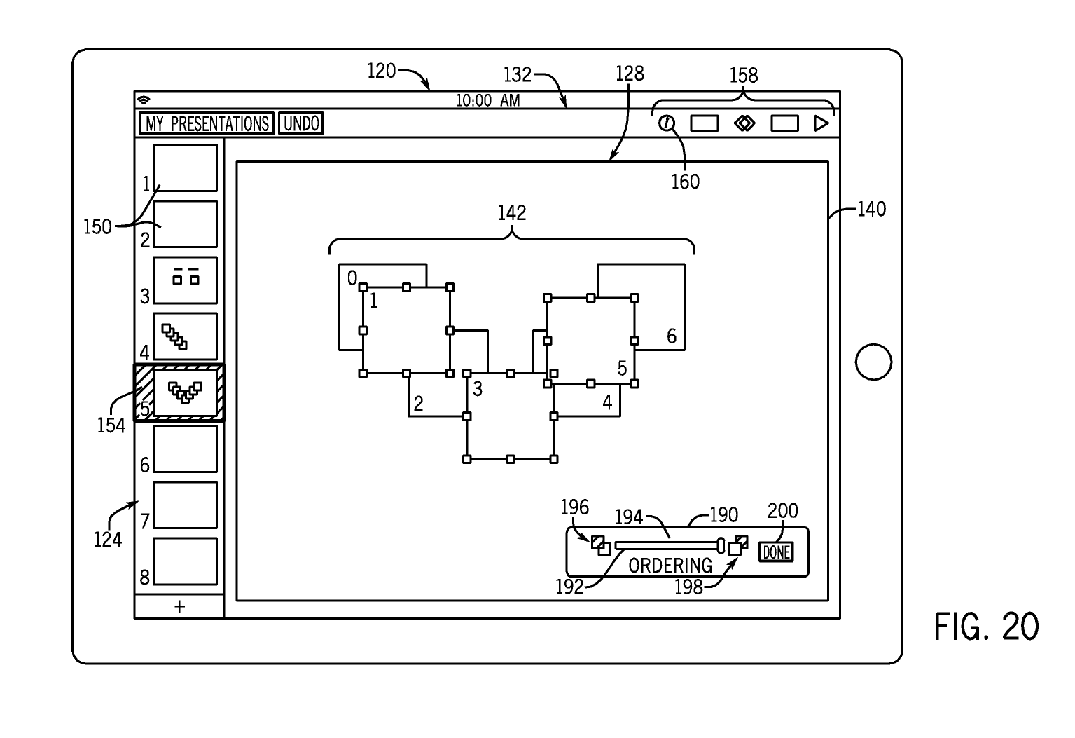

FIGS. 19 and 20 depict another example for adjusting the z-ordering of concurrently selected non-contiguous objects. Referring first to FIG. 19, the initial ordering of the objects 142 of current slide 140 is, from the lowest z-order position to the highest z-order position, block 0, block 1, block 2, block 3, block 4, block 5, and block 6, with blocks 1, 3, and 5 being concurrently selected non-contiguous objects (as shown by the selection indicator points 168) for editing by a user.

Next, FIG. 20 illustrates the movement of the slider indicator 194 from the position shown in FIG. 19 to the rightmost position of the slider 192. Thus, the adjustment of the z-order positions of the selected non-contiguous blocks 1, 3, and 5 may occur as follows. First, as described above, the direction of the z-order adjustment is determined by evaluating the manner in which a user moves the indicator 194 along the slider 192. Because the slider 194 is moved to the right in FIG. 20, the z-order adjustment direction is in the increasing z-direction. Thus, block 5, which has the greatest z-order position of the selected objects (blocks 1, 3, and 5), becomes the reference object. Accordingly, the z-order position of block 5 is increased by one z-order position. Concurrently, the z-order position of block 3 is increased by two z-order positions, and the z-order position of block 1 is increased by three z-order positions, such that after the z-order adjustment, blocks 1, 3, and 5 are contiguous in the z-direction, but maintain their relative z-ordering with respect to another (e.g., block 5 is above block 3 which is above block 1). Thus, after the z-order editing performed in FIG. 20, the objects 142 may be ordered from the lowest z-order position to the highest z-order position as follows: block 0, block 2, block 4, block 6, block 1, block 3, and block 5.

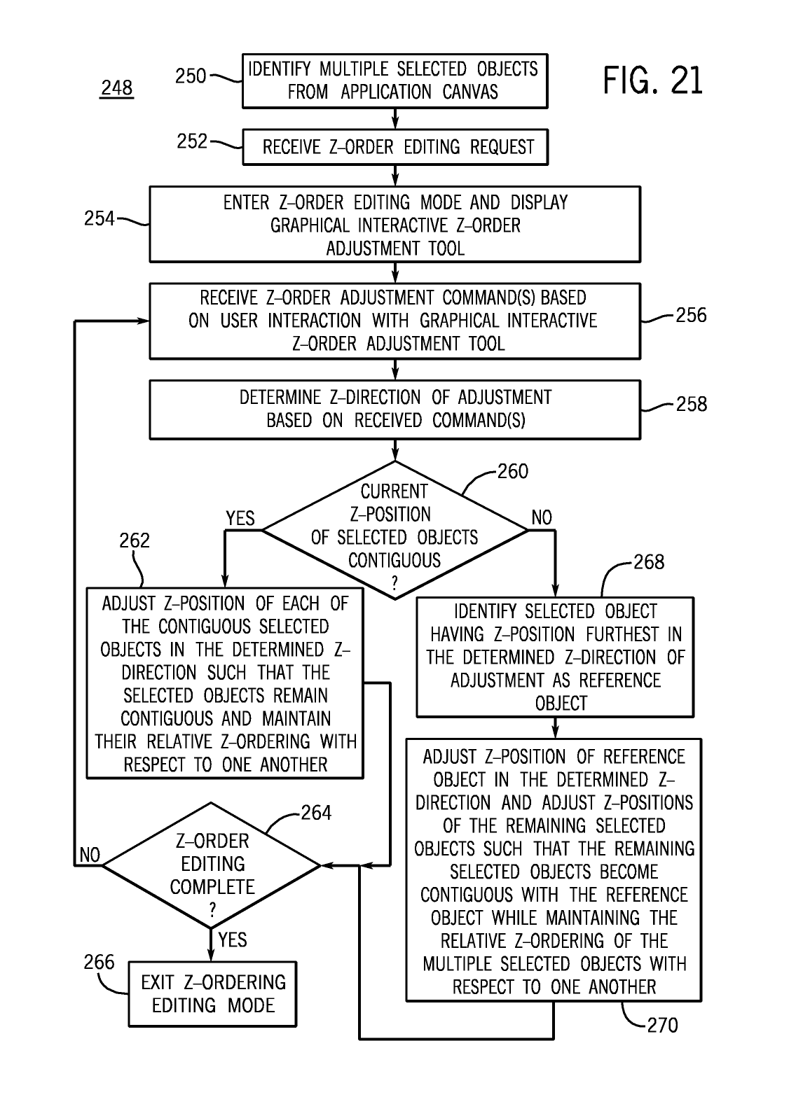

While the above illustrated embodiments depict the adjustment of two concurrently selected objects 142 (FIGS. 14-18) and of three concurrently selected objects 142 (FIGS. 19-20) within the slide 140, it should be understood that the presently disclosed techniques could be applied to any number of selected objects 142 within a particular slide 140. Referring now to FIG. 21, these techniques are further illustrated by way of a flowchart depicting a method 248. Beginning at block 250 of the method 248, multiple objects are selected from a group of objects from a slide displayed within the slide canvas 128 of the screen 120. At block 252, a request to edit z-ordering properties of the multiple selected objects is received. For instance, block 252 may correspond to the selection the inspector icon 160 from the toolbar options 158 and of the graphical button 178 from the subsequently displayed graphical window 170 (FIG. 6). The method 248 then proceeds to block 254, wherein the presentation application 88 enters a z-ordering editing mode and a graphical interactive tool (e.g., combination of slider 192 and indicator 194) is provided to a user for making z-ordering adjustments with respect to the selected objects 142.

At block 256, one or more z-order adjustment commands may be received based upon user inputs provided via the graphical interactive tool and, thereafter, at block 258, a desired z-direction of adjustment is determined based upon the user inputs. Subsequently, at block 260, a determination is made as to whether all of the currently selected objects are contiguous in the z-direction. If the selected objects are already contiguously arranged, then the method 248 continues to block 262, wherein the z-order position of each of the contiguous selected objects is adjusted in the selected z-direction (from block 258), such that after the z-order adjustment, the selected objects 142 remain contiguous in the z-direction and maintain their relative z-ordering with respect to one another (FIGS. 14-15). Subsequently, the method 248 continues to decision block 264 to determine whether the z-order editing process is completed. If it is determined that the z-order editing process is not completed (e.g., the user has not selected the “DONE” button 200 from window 190), then the method 248 returns to block 256 to receive additional z-order adjustment commands. However, if it is determined at block 264 that the z-order editing process is completed, the method 248 ends at block 266, in which the z-order editing mode is exited.

Returning to decision block 260, if it is determined that the selected objects 142 are not contiguously arranged in the z-direction, the method 248 continues instead to block 268. As shown at block 268, a reference object is identified from the multiple selected objects by determining the selected object having the z-order position that is furthest in the selected z-direction (from block 258). Thereafter, at block 270, the z-order position of the reference object is adjusted based upon the selected z-direction, and z-order positions of the remaining selected objects are adjusted such that they become contiguous with the adjusted reference object while all the selected objects maintain their relative z-ordering with respect to one another after the adjustment. Next, the method proceeds to decision block 264. As discussed above, if the z-order editing process is not complete, the method 248 may return to block 256 to receive additional z-order adjustment commands. If it is determined at block 264 that the z-order editing process is completed, the method 248 ends at block 266.

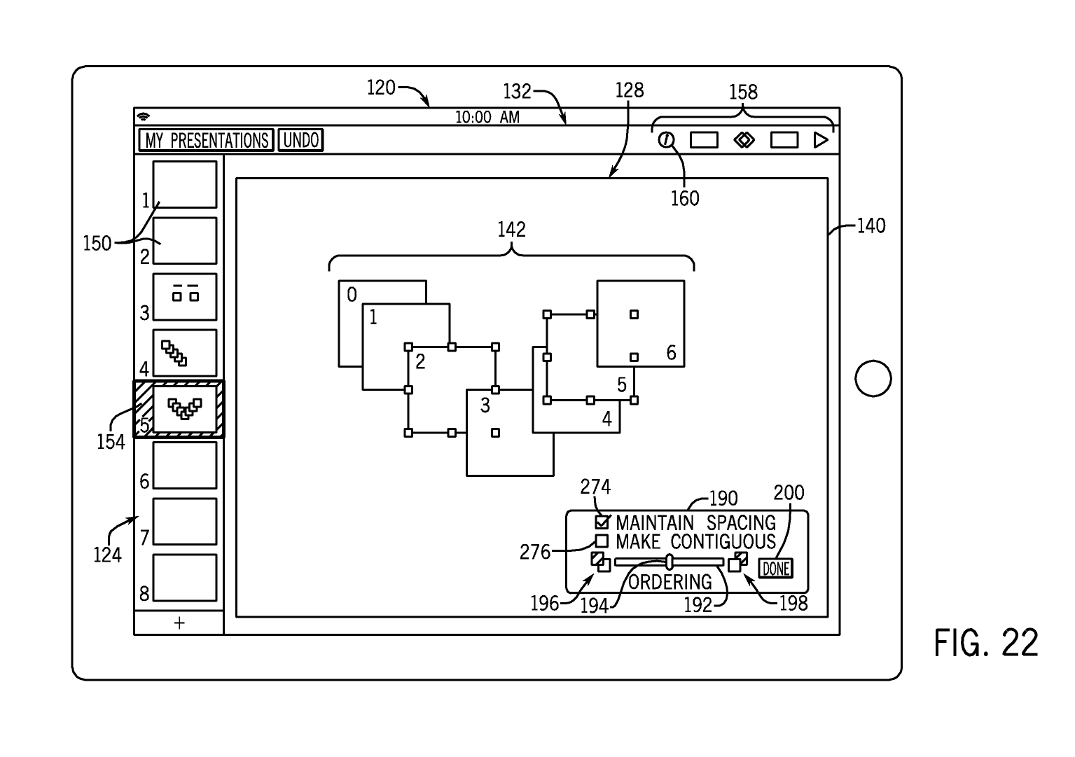

Referring now to FIGS. 22-24, a further embodiment of a technique for adjusting the z-ordering of multiple concurrently selected non-contiguous objects 142 is illustrated. In particular, FIGS. 22-24 illustrate an embodiment in which the spacing between the z-positions of multiple non-contiguous objects 142 is maintained during z-order adjustments. For instance, referring first to FIG. 22, the objects 142 of the current slide 140 are initially arranged such that each object 142 has a unique z-order position, and such that the objects 142, when listed in order from the lowest z-order position to the highest z-order position, include: block 0, block 1, block 2, block 3, block 4, block 5, and block 6. FIG. 22 also indicates that of these seven objects 142, multiple non-contiguous objects, here block 2 and block 5 (as shown by the selection indicator points 168), are presently selected for editing by a user.

As discussed above, the z-order positions of the selected blocks 2 and 5 may be adjusted by moving the position of the indicator 194 on the slider 192 either towards the graphic 96 or the graphic 98 within the editing window 190. Further, in the embodiment depicted in FIG. 22, the editing window 190 also includes the checkbox element 274, which corresponds to a selectable option for maintaining the spacing between z-ordered objects during z-order adjustments, as well as the checkbox element 276, which corresponds to a selectable option for making selected objects contiguous after a z-order adjustment (e.g., as shown in FIGS. 16-20). Thus, the present embodiment allows a user to select whether to maintain the z-order spacing between selected objects 142 during z-order adjustment, or to make the selected objects contiguous as a result of a z-order adjustment. As shown in FIG. 22, the checkbox element 274 is presently selected, thus indicating that the user wishes to maintain the z-order spacing between the selected blocks 2 and 5, which are initially spaced by apart by two levels in the z-direction (e.g., spaced apart by blocks 3 and 4). As will be appreciated, other types of graphical selection elements, including radio buttons, switches, and so forth, may be used in other embodiments.

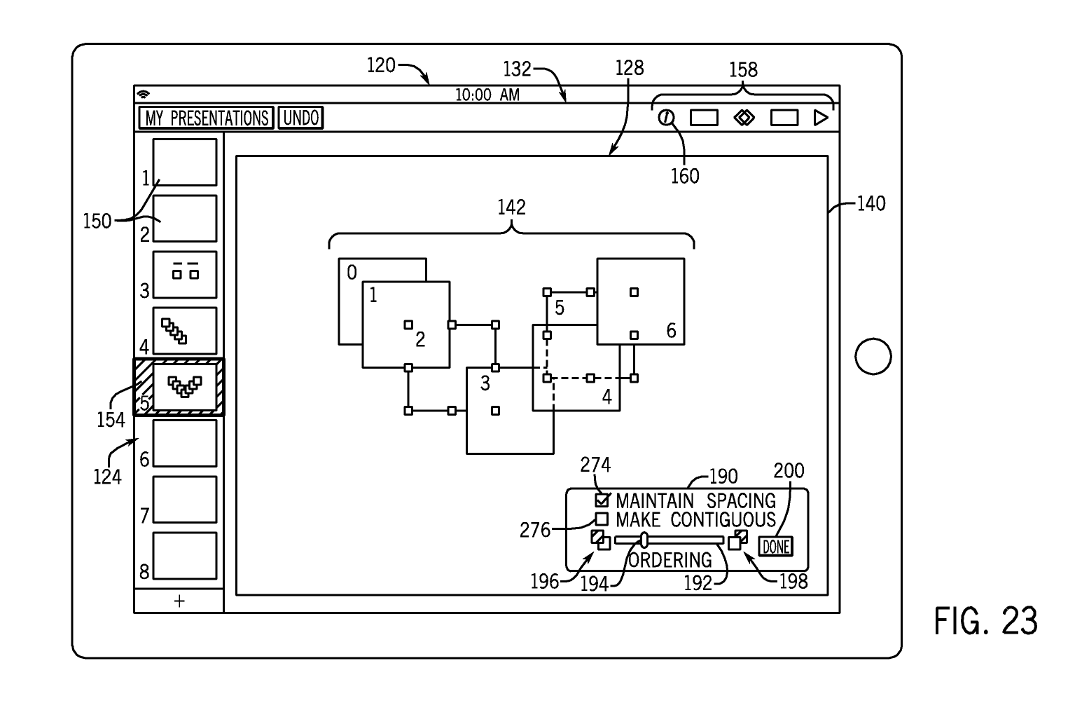

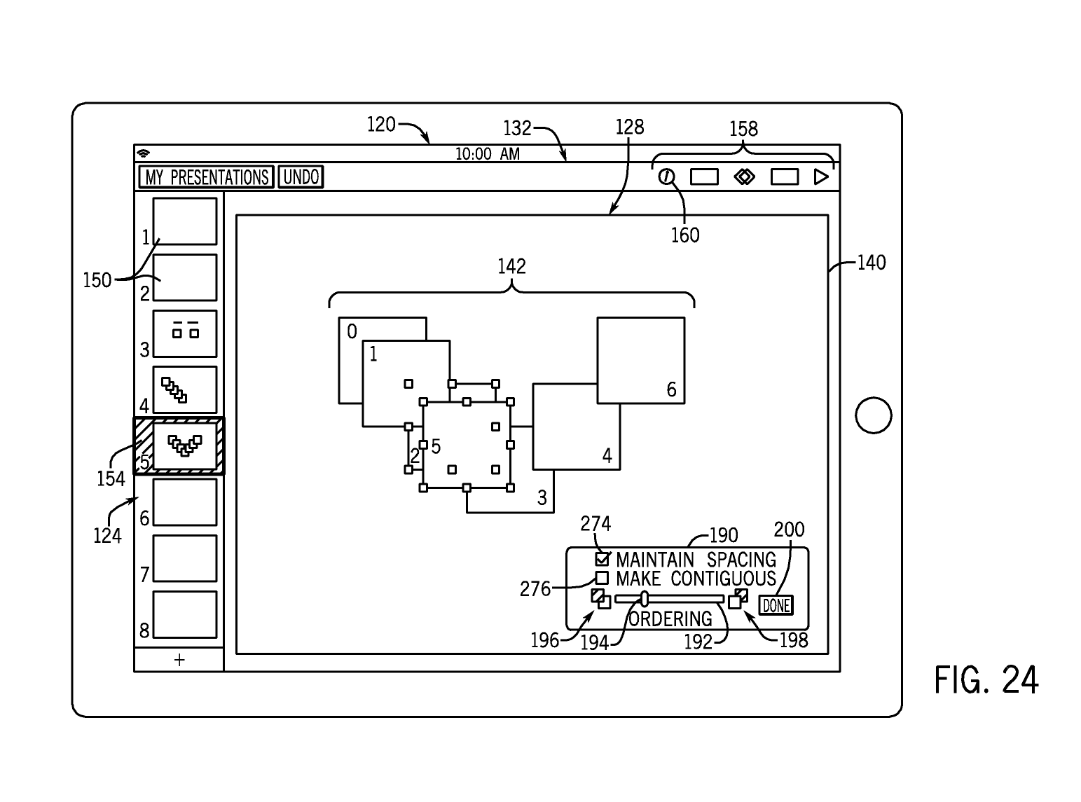

FIG. 23 illustrates the adjustment of the z-order positions of blocks 2 and 5, after a user has moved the indicator 194 from the position shown in FIG. 22 toward the left end of the slider 192 to the current position shown in FIG. 23. This causes the z-order positions of each of the selected objects 142 (blocks 2 and 5) to be reduced while maintaining their relative z-ordering and spacing with respect to one another. For instance, as a result of the user input in FIG. 23, the z-order positions of each of the selected blocks 2 and 5 may decrease by one level in the z-direction. Thus, the adjusted z-order of the objects 142, from lowest to highest, is block 0, block 2, block 1, block 3, block 5, block 4, and block 6. That is, while each of blocks 2 and 5 have their z-order positions decreased, the adjusted z-order positions of blocks 2 and 5 still maintains the initial spacing of two levels in the z-direction (e.g., corresponding to the current z-order positions of blocks 1 and 3). To better illustrate these relative adjusted positions of blocks 2 and 5, FIG. 24 shows the objects 142 from FIG. 23, but with block 5 moved in the x and y directions (horizontally and vertically) to more clearly show that blocks 1 and 3 are between blocks 2 and 5, thus allowing blocks 2 and 5 to retain their initial z-order spacing (e.g., two levels).

It should be further noted that if blocks 2 and 5 were to be adjusted in the decreasing z-direction once again, then the updated z-ordering of the objects 142, from lowest to highest z-order positions, would be: block 2, block 0, block 1, block 5, block 3, block 4, and block 6. That is, block 2 would now be in the lowest z-order position. As such, no further adjustments of blocks 2 and 5 would be permitted by the presentation application 88 while the checkbox 274 is selected, as the z-order position of block 2 could not be further reduced, and the z-order position of block 5 could not be further reduced while also maintaining the initial spacing.

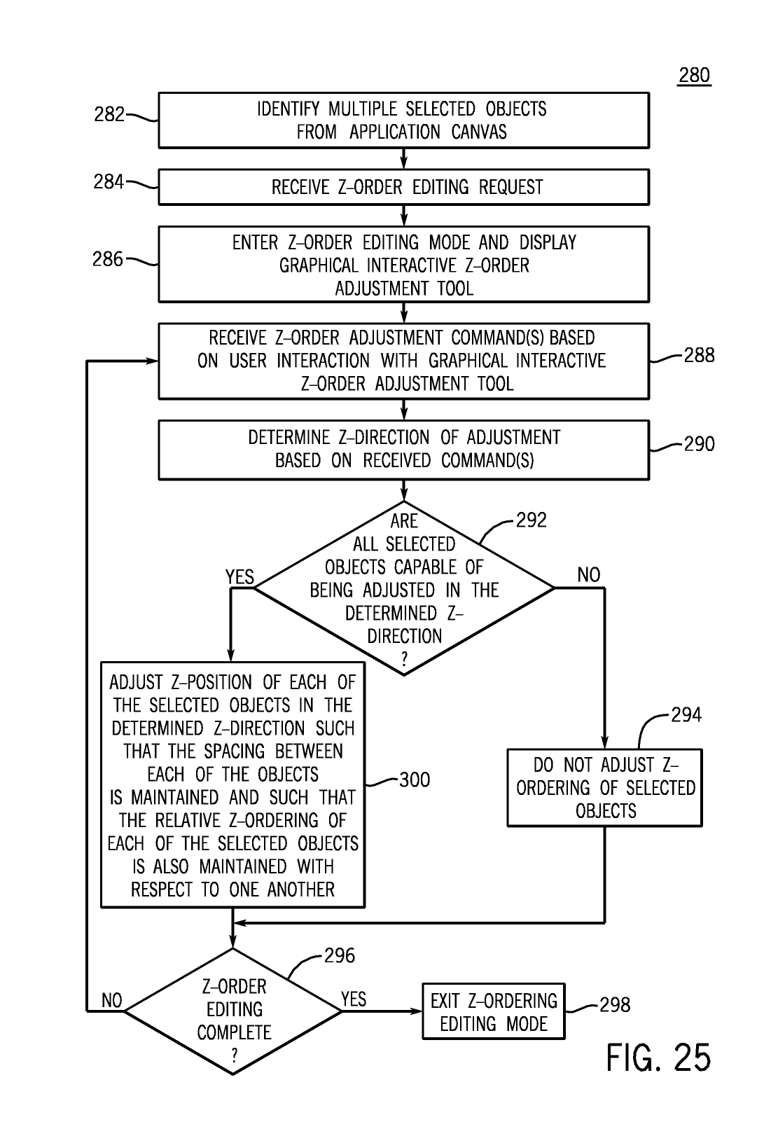

Referring now to FIG. 25, the techniques depicted in FIGS. 22-24 are further illustrated by way of a flowchart depicting a method 280. Beginning at block 282 of the method 280, multiple objects are selected from a group of objects 142 from a slide displayed within the slide canvas 128 of the screen 120. At block 284 a request to edit z-ordering properties of the multiple selected objects is received. For instance, block 284 may correspond to the selection the inspector icon 160 from the toolbar options 158 and of the graphical button 178 from the subsequently displayed graphical window 170 (FIG. 6). The method 280 then proceeds to block 286, wherein the presentation application 88 enters a z-ordering editing mode and a graphical interactive tool (e.g., combination of slider 192 and indicator 194) is provided to a user for making z-ordering adjustments with respect to the selected objects 142.

At block 288, one or more z-order adjustment commands may be received based upon user inputs provided via the graphical interactive tool and, thereafter, at block 290, a desired z-direction of adjustment is determined based upon the user inputs. Subsequently, at block 292, a determination is made as to whether all of the selected objects are capable of being adjusted in the selected z-direction determined at block 290. For instance, as discussed above, this determination may be based upon whether one of the selected objects 142 already has the furthest possible z-order position in the selected z-direction (e.g., the lowest z-order position of 0 when the decreasing z-direction is selected, or the highest z-order position of n−1 when the increasing z-direction is selected). If, at decision block 290, it is determined that at least one of the selected objects 142 cannot be adjusted in the selected z-direction, then the z-ordering of the selected objects 142 is not adjusted, as indicated at block 294.

Thereafter, the method 280 continues to decision block 296 to determine whether the z-order editing process is completed. If it is determined that the z-order editing process is not completed (e.g., the user has not selected the “DONE” button 200 from window 190), then the method 280 returns to block 288 to receive additional z-order adjustment commands. However, if it is determined at decision block 296 that the z-order editing process is completed, the method 280 ends at block 298, in which the z-order editing mode is exited.

Returning to decision block 292, if it is determined that all of the selected objects 142 are capable of being adjusted in the selected z-direction from block 290, then the method 280 continues instead to block 300. As shown at block 300, the z-order positions of the selected objects are adjusted in the selected z-direction such that all the selected objects maintain both their relative z-ordering with respect to one another and their spacing between one another in the z-direction after the adjustment. Following block 300, the method 280 may proceed to decision block 296. As discussed above, if the z-order editing process is not complete, the method 280 may return to block 288 to receive additional z-order adjustment commands or, if it is determined at decision block 296 that the z-order editing process is completed, the method 280 ends at block 298.

As will be understood, the various techniques described above and relating to z-order adjustment of objects displayed on a user interface (e.g., within a presentation application 88, a spreadsheet application, a word processing application, an image editing application, etc.) are provided herein by way of example only. Accordingly, it should be understood that the present disclosure should not be construed as being limited to only the examples provided above. Indeed, a number of variations of the z-order adjustment techniques set forth above may exist. Further, it should be appreciated that the above-discussed techniques may be implemented in any suitable manner. For instance, such techniques may be implemented using hardware (e.g., suitably configured circuitry), software (e.g., via a computer program including executable code stored on one or more tangible computer readable medium), or via using a combination of both hardware and software elements, such as the electronic device 10 having suitable configured software applications stored within a computer readable medium (e.g., memory/storage device 14).

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A method comprising:
selecting at least one object from a plurality of objects provided via an interface of an application, the interface being displayed on an electronic device, wherein each of the plurality of objects has an associated z-order position in the interface; and
initiating a z-order editing process by displaying an interactive graphical structure that is adjustable by a user of the electronic device to interactively control an adjustment in the z-order position associated with the at least one selected object, and dynamically updating the interface to reflect the adjustment in the z-order position associated with the at least one selected object as the user interacts with the interactive graphical structure.

2. The method of claim 1, wherein the interactive graphical structure comprises a slider having an indicator moveable along an axis of the slider between a plurality of positions, wherein the position of the indicator and the direction in which the indicator is moved determines the adjustment of the z-order position associated with the at least one selected object.

3. The method of claim 2, wherein movement of the indicator in a first direction along the slider axis decreases the z-order position associated with the at least one selected object, and wherein the movement of the indicator in a second direction opposite the first direction along the slider axis increases the z-order position associated with the at least one selected object.

4. The method of claim 2, wherein the indicator is configured to be responsive to touch inputs provided by the user.

5. The method of claim 1, wherein the application comprises a presentation application, and wherein the interface comprises a slide canvas displaying a slide containing the plurality of objects.

6. The method of claim 1, comprising displaying a z-order editing window upon receiving a request from the user to initiate the z-order editing process, wherein the interactive graphical structure is displayed within a z-order editing window.

7. Computer readable media comprising a computer program product, the computer program product comprising routines which, when executed on a processor, perform the following:
selecting a slide from a plurality of selectable slide representations displayed in a navigator pane of a presentation application based upon a first user input, wherein the selected slide includes a plurality of objects, each having a respective z-order position within the selected slide;
selecting two or more objects from the selected slide for z-order editing;
entering a z-order editing mode by displaying a z-order editing window comprising an interactive graphical structure that provides for adjustment of the z-order positions of the selected two or more objects in response a second user input; and
adjusting the z-order positions associated with the selected two or more objects based upon the second user input, such that the selected two or more objects maintain their relative z-order positions with respect to one another after the adjustment.

8. The computer readable media of claim 7, wherein adjusting the z-order positions associated with the selected two or more objects comprises providing a dynamic preview of the adjustment on the selected slide.

9. The computer readable media of claim 7, comprising exiting the z-order editing mode in response to a third user input.

10. The computer readable media of claim 9, wherein the z-order editing window comprises a graphical button responsive to the third user input, and wherein the graphical button, upon being selected by the third user input, causes the z-order editing mode to exit.

11. The computer readable media of claim 7, wherein the interactive graphical structure comprises a horizontally oriented graphical slider, a vertically oriented graphical slider, a three-dimensional graphical slider, a graphical dial, or some combination thereof.

12. The computer readable media of claim 7, wherein the z-order editing window comprises a first selectable option and a second selectable option, wherein:
if the first selectable option is selected, a spacing in the z-direction between the selected two or more objects is maintained after the adjustment; and
if the second selectable option is selected, the selected two or more objects become contiguous in the z-direction after the adjustment.

13. The computer readable media of claim 12, wherein the first and second selectable options are represented by graphical checkboxes, graphical radio buttons, graphical switches, or some combination thereof.

14. A method comprising:
identifying two or more concurrently selected objects from a plurality of objects displayed on a selected slide of a presentation application, each of the plurality of objects having an associated z-order position;
receiving a z-ordering adjustment command for adjusting the two or more concurrently selected objects;
adjusting the z-ordering of the two or more concurrently selected objects based upon the received z-ordering adjustment command, wherein the relative z-ordering of the two or more concurrently selected objects remains the same with respect to one another after the adjustment, and wherein the two or more concurrently selected objects are adjusted as a group, such that the z-order positions of the two or more concurrently selected objects are contiguous in the z-direction after the adjustment regardless of whether the z-order positions of the two-or more concurrently selected objects was contiguous in the z-direction prior to the adjustment.

15. The method of claim 14, comprising providing a interactive graphical structure for receiving z-ordering adjustment commands, wherein the z-ordering adjustment command for adjusting the two or more concurrently selected objects is received via the interactive graphical structure.

16. The method of claim 15, wherein the interactive graphical structure comprises at least one touch-sensitive element that enables a user to interact with the interactive graphical structure via a touch sensitive interface.

17. The method of claim 14, wherein adjusting the z-ordering of the two or more concurrently selected objects comprises:
determining a selected z-order direction of adjustment based upon the received z-ordering adjustment command; and
adjusting the z-order positions of the two or more concurrently selected objects in the selected z-order direction of adjustment.

18. The method of claim 17, wherein if at least two of the two or more concurrently selected objects are not contiguous in the z-direction with respect to one another prior to the adjustment, adjusting the two or more concurrently selected objects as a group comprises:
identifying a reference object from the two or more concurrently selected objects as being the object having a z-order position that is furthest in the selected z-order direction of adjustment;
adjusting the z-order position of the reference object by one position in the selected z-order direction; and
adjusting the z-order positions of each of the remaining concurrently selected objects, such that the remaining concurrently selected objects are contiguous with the reference object after the adjustment.

19. The method of claim 17, wherein if all of the two or more concurrently selected objects are contiguous in the z-direction with respect to one another prior to the adjustment, adjusting the two or more concurrently selected objects as a group comprises adjusting the z-order positions of each of the two or more concurrently selected objects by the same number of positions in the selected z-order direction.

20. The method of claim 14, wherein the selected slide is dynamically updated during the z-ordering adjustment.

21. An electronic device, comprising:
a processor;
a display device;
a memory device storing an application configured to be executed by the processor, wherein the application comprises:
an interface that displays a plurality of objects on the display device, each of the plurality of objects having an associated z-order position; and
an editing mode configured to identify two or more selected objects from the plurality of objects, to receive a z-ordering adjustment command in a z-order editing window, and to adjust the z-order positions associated with the two or more selected objects in response to the z-ordering adjustment command, such that the two or more selected objects maintain their relative z-ordering with respect to one another after the adjustment, and wherein the application provides a dynamic preview reflecting changes in the z-ordering of the two or more selected objects during the adjustment.

22. The electronic device of claim 21, wherein the display device comprises a touch screen interface.

23. The electronic device of claim 22, wherein the z-order editing window comprises an interactive graphical structure having at least one element responsive to touch inputs received via the touch screen interface.

24. The electronic device of claim 21, wherein the electronic device comprises a desktop computer, a laptop computer, a tablet computing device, or a portable handheld computing device.

25. The electronic device of claim 21, wherein the application comprises one of a presentation application, a word processing application, a spreadsheet application, an image editing application, or some combination thereof.
